(19) United States
(12) Patent Application Publication
(10) Pub. No.: US 2008/0168450 A1
(43) Pub. Date: Jul. 10, 2008

(54) PRINTING SYSTEM, METHOD FOR CONTROLLING THE PRINTING SYSTEM, PRINTING APPARATUS, AND STORAGE MEDIUM

(75) Inventor: Takeshi Tarumi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/969,357

(22) Filed: Jan. 4, 2008

(30) Foreign Application Priority Data
Jan. 5, 2007 (JP) 2007-000513

(51) Int. Cl. G06F 9/46

(52) U.S. Cl. 718/102

(57) ABSTRACT

When two or more print jobs are present, a printing system allows a user to perform a test print of a designated print job prior to execution of other print jobs. The printing system selects a print job to be processed by a printer unit from a plurality of print jobs waiting for print processing. A first job is currently processed by the printer unit. A second job follows the first job and is scheduled to be processed by the printer unit and a third job follows the second job. The printing system controls the printer unit to execute, in case where the third job is selected and an instruction to execute priority test print processing of the third job is accepted, the test print processing of the third job after completing print processing of the first job and before starting print processing of the second job.

### BACKGROUND OF THE INVENTION

1. Field of the Invention

The present invention relates to a printing system that can accept a plurality of print jobs, a method for controlling the printing system, a printing apparatus, and a storage medium.

2. Description of the Related Art

A conventional printing system, such as a Print on Demand (POD) system, allows an operator who may not be present in the vicinity of a printing system to instruct the printing system to print a great amount of print job data.

In such an environment, an operator may want to confirm a finishing state (i.e., print result) of print job data. Even in a situation where a preceding print job is currently executed, an operator may want to confirm a finishing state of a following print job waiting for print processing.

However, if a printing system has already accepted a great amount of print job data, an operator cannot confirm a print result of an intended print job before completing print processing of the accepted print jobs.

### SUMMARY OF THE INVENTION

Exemplary embodiments of the present invention are directed to a printing system that allows a user to preferentially perform a test print of a designated print job prior to execution of other print jobs when a plurality of unprocessed print jobs are present, so that a user can promptly confirm a print result of the designated print job.

Furthermore, the exemplary embodiments of the present invention are directed to a printing system that can execute test print processing of a print job without greatly changing an original processing order designated by an operator even when the test print processing is performed prior to execution of other print jobs.

According to an aspect of the present invention, a printing system is capable of accepting a plurality of print jobs. The printing system includes a selection unit configured to select a print job to be processed by a printer unit from a plurality of print jobs waiting for print processing, wherein the plurality of print jobs includes a first job being currently processed by the printer unit, a second job following the first job and scheduled to be processed by the printer unit, and a third job following the second job and scheduled to be processed by the printer unit. Furthermore, the printing system includes a control unit configured to control the printer unit to execute, in case where the third job is selected by the selection unit and an instruction to execute priority test print processing of the third job is accepted, the test print processing of the third job after completing print processing of the first job and before starting print processing of the second job.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates a print environment including a printing system according to an exemplary embodiment of the present invention.

FIG. 2 illustrates a printing system according to an exemplary embodiment of the present invention.

FIG. 3 illustrates a printing system according to an exemplary embodiment of the present invention.

FIG. 4 illustrates an example of user interface (UI) unit according to an exemplary embodiment of the present invention.

FIG. 5 is a flowchart illustrating an example of data processing procedure according to an exemplary embodiment of the present invention.

FIG. 6 is a flowchart illustrating an example of data processing procedure according to an exemplary embodiment of the present invention.

FIG. 7 illustrates a display control example for the UI unit according to an exemplary embodiment of the present invention.

FIG. 8 illustrates a display control example for the UI unit according to an exemplary embodiment of the present invention.

FIG. 9 illustrates a display control example for the UI unit according to an exemplary embodiment of the present invention.

FIG. 10 illustrates a display control example for the UI unit according to an exemplary embodiment of the present invention.

FIG. 11 illustrates a display control example for the UI unit according to an exemplary embodiment of the present invention.

FIG. 12 illustrates a display control example for the UI unit according to an exemplary embodiment of the present invention.

FIG. 13 illustrates a display control example for the UI unit according to an exemplary embodiment of the present invention.

FIG. 14 illustrates a display control example for the UI unit according to an exemplary embodiment of the present invention.

FIG. 15 illustrates a display control example for the UI unit according to an exemplary embodiment of the present invention.

FIG. 16 illustrates a display control example for the UI unit according to an exemplary embodiment of the present invention.

FIG. 17 illustrates a display control example for the UI unit according to an exemplary embodiment of the present invention.

FIG. 18 illustrates a display control example for the UI unit according to an exemplary embodiment of the present invention.

FIG. 19 is a flowchart illustrating an example of data processing procedure according to an exemplary embodiment of the present invention.

FIG. 20 illustrates a display control example for the UI unit according to an exemplary embodiment of the present invention.

FIG. 21 illustrates a display control example for the UI unit according to an exemplary embodiment of the present invention.

FIG. 22 illustrates a display control example for the UI unit according to an exemplary embodiment of the present invention.

FIG. 23 is a flowchart illustrating an example of data processing procedure according to an exemplary embodiment of the present invention.

FIG. 24 illustrates a display control example for the UI unit according to an exemplary embodiment of the present invention.

FIG. 25 is a flowchart illustrating an example of data processing procedure according to an exemplary embodiment of the present invention.

### DETAILED DESCRIPTION OF THE EMBODIMENTS

The following description of exemplary embodiments is illustrative in nature and is in no way intended to limit the invention, its application, or uses. Processes, techniques, apparatus, and systems as known by one of ordinary skill in the art are intended to be part of the enabling description where appropriate. It is noted that throughout the specification, similar reference numerals and letters refer to similar items in the following figures, and thus once an item is described in one figure, it may not be discussed for following figures. Exemplary embodiments will be described in detail below with reference to the drawings.

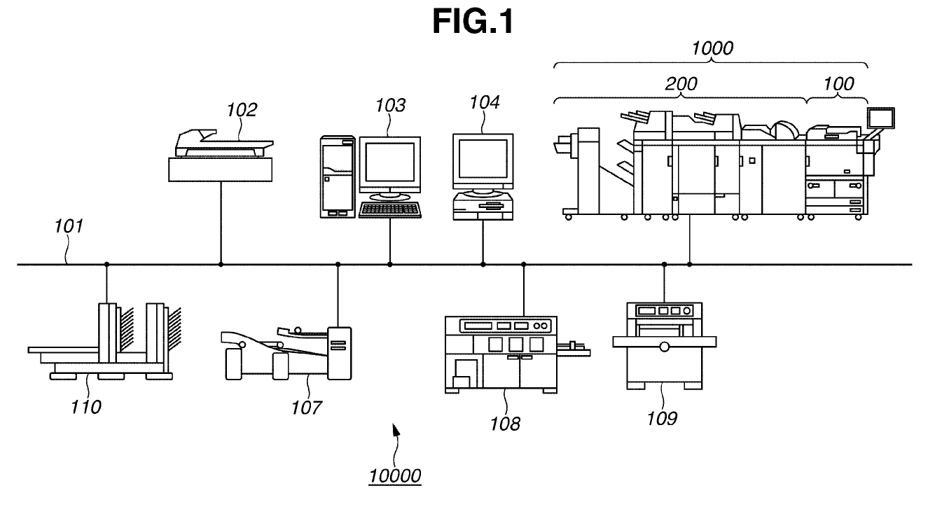

A print environment 10000 illustrated in FIG. 1 is a print environment, such as a POD system environment, according to an exemplary embodiment of the present invention. However, the printing system according to the present invention is not limited to a printing system in the POD environment and may be a printing system used in an office environment. The print environment 10000 may be referred to as POD system 10000.

The POD system 10000 includes a printing system 1000, a server computer 103 (hereinafter, referred to as PC 103) and a client computer 104 (hereinafter, referred to as PC 104). The POD system 10000 further includes a paper folding machine 107, a case binding machine 108, a sheet cutting machine 109, a saddle stitch binding machine 110, and a scanner 102.

The printing system 1000 includes a printing apparatus (apparatus body) 100 and a sheet processing apparatus 200. An example of the printing apparatus 100 is a multifunction peripheral (MFP) that has a plurality of functions including a copy function and a personal computer (PC) print function. The printing apparatus 100 may be a printing apparatus having only the PC function or the copy function.

The sheet processing apparatus 200 of the printing system 1000, the paper folding machine 107, the case binding machine 108, the sheet cutting machine 109, and the saddle stitch binding machine 110 are referred to as sheet processing apparatus.

The paper folding machine 107 executes processing for folding the sheets of a job printed by the printing apparatus 100. The case binding machine 108 executes processing for case binding the sheets printed by the printing apparatus 100. The sheet cutting machine 109 executes processing for cutting sheets printed by the printing apparatus 100. The saddle stitch binding machine 110 executes processing for saddle stitch binding the sheets of a job printed by the printing apparatus 100.

To enable the above-described sheet processing apparatuses to execute various sheet processing, an operator (i.e., a user) is required to perform a manual work after the printing apparatus 100 has completed print processing. More specifically, the operator takes the printed sheets out of a paper discharge section of the printing apparatus 100 and conveys the sheets to an intended sheet processing apparatus that performs required sheet processing.

On the other hand, if the sheet processing apparatus 200 is used for the sheet processing, an operator is not required to perform a manual work after the printing apparatus 100 has completed print processing. This is because the sheet processing apparatus 200 can directly receive printed sheets via an internal sheet conveying path of the printing apparatus 100. Furthermore, the printing apparatus 100 and the sheet processing apparatus 200 are electrically connected with each other and perform data communications using built-in central processing units (CPUs).

The sheet processing apparatus according to an exemplary embodiment may be referred to as a post-processing apparatus or a postpress apparatus. All of the sheet processing apparatuses involved in the POD system 10000, except for the saddle stitch binding machine 110, are connected to a network 101 so that the sheet processing apparatuses can perform data communication with other apparatuses.

For example, the printing apparatus 100 performs print processing of a job (including print settings and print data) transmitted from information processing apparatus (e.g., the PC 103, the PC 104, etc) via the network 101.

The PC 103 executes data transmission/reception processing with other apparatuses via the network 101 and manages all jobs to be processed by the POD system 10000. In other words, the PC 103 performs an integrated management for a series of work flows including a plurality of processes.

Each sheet processing apparatus in the above-described POD system 10000 can be classified into one of the following three types, i.e., Definition 1 to Definition 3.

Definition 1

A sheet processing apparatus satisfying the following two conditions, i.e., condition 1 and condition 2, is defined as “inline finisher” (or inline-type sheet processing apparatus).

Condition 1

A sheet conveying path is physically connected to the printing apparatus 100 so that the sheet processing apparatus can directly receive a printed sheet from the printing apparatus 100 without any manual work by an operator.

Condition 2

The sheet processing apparatus is electrically connected to other apparatuses, for example, via the network 101, to perform data communications for operational instructions and status confirmation.

For example, the sheet processing apparatus 200 in the printing system 1000 is an “inline finisher” satisfying the above-described two conditions 1 and 2.

Definition 2

A sheet processing apparatus satisfying the condition 2 and not satisfying the condition 1 is defined as “nearline finisher” (or nearline-type sheet processing apparatus).

The nearline finisher does not have a sheet conveying path connected to the printing apparatus 100 and requires an operator's manual work including transport of print products. However, the nearline finisher can perform data communication (e.g., transmission/reception of operational instructions and status confirmation) via the network 101 or other communication unit.

For example, the paper folding machine 107, the case binding machine 108, and the sheet cutting machine 109, are “nearline finishers” which do not satisfy the condition 1 but satisfy the condition 2.

Definition 3

A sheet processing apparatus not satisfying both the condition 1 and the condition 2 is defined as “offline finisher” (or offline-type sheet processing apparatus).

The offline finisher does not have a sheet conveying path connected to the printing apparatus 100 and requires an operator's manual work including transport of print products. Furthermore, the offline finisher does not include a communication unit and cannot perform data communication (e.g., transmission/reception of operational instructions and status confirmation) via the network 101 or other communication unit.

Therefore, an operator of the offline finisher is required to transport and set print products and manually instruct processing of print products.

For example, the saddle stitch binding machine 110 of FIG. 1 is an “offline finisher.” As described above, various sheet processing apparatuses classified into three types (Definition 1 to Definition 3) enable an operator to execute various sheet processing.

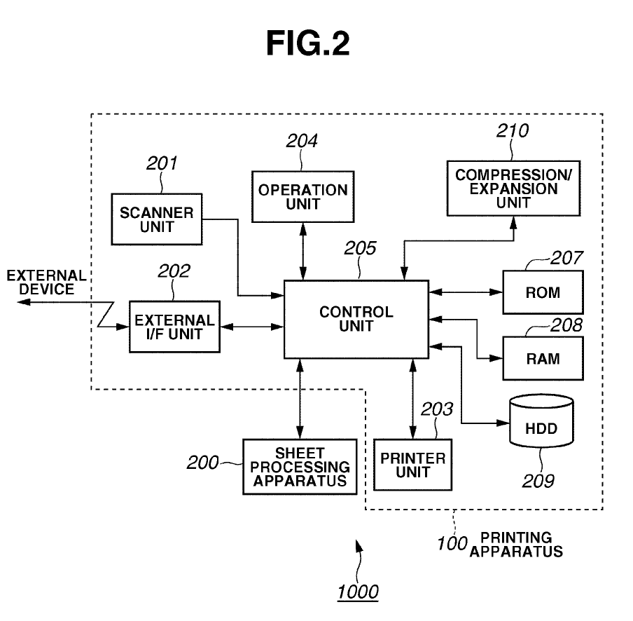

An internal configuration (software structure) of the printing system 1000 is described below with reference to a system block diagram of FIG. 2. According to an exemplary embodiment, all the units except for the sheet processing apparatus 200 are incorporated in the printing apparatus 100. Furthermore, the sheet processing apparatus 200 is detachably assembled with the printing apparatus 100.

The printing apparatus 100 includes a nonvolatile memory, such as a hard disk drive 209 (hereinafter, referred to as HDD), which can store data of a plurality of jobs. Furthermore, the printing apparatus 100 includes a printer unit 203 that performs a copy operation for printing the data of the received job via the HDD 209 from a scanner unit 201.

Furthermore, the printing apparatus 100 has a print function performed by the printer unit 203 that prints job data received from an external apparatus (e.g., the PC 103, the PC 104, etc) via an external I/F unit 202 and stored in the HDD 209. The printing apparatus 100 is a color printing apparatus or a monochrome printing apparatus, or may be other printing apparatus that can execute various controls according to an exemplary embodiment.

The printing apparatus 100 according to an exemplary embodiment includes the scanner unit 201, the external I/F unit 202, the printer unit 203, an operation unit 204, a control unit 205, a read only memory (ROM) 207, a random access memory (RAM) 208, the HDD 209, and a compression/expansion unit 210. The scanner unit 201 reads a document image and performs image processing on read image data. The external I/F unit 202 performs transmission/reception of image data with a facsimile, a network device, and an external dedicated apparatus.

The HDD 209 stores image data of a plurality of print objects (jobs) received from the scanner unit 201 or the external I/F unit 202. The printer unit 203 executes print processing for reading printing job data of a designated print object from the HDD 209 and printing the readout job data onto a print medium.

The operation unit 204 functions as an interface unit that accepts an operation or an instruction from a user. The operation unit 204 includes a display unit. Another example of the user interface unit for the printing system 1000 is, for example, a display unit, a keyboard, or a mouse of an external information processing apparatus (e.g., the PC 103 or the PC 104).

The control unit 205 (which may be referred to as “controller unit” or central processing unit (CPU)) comprehensively controls processing and operations of various units in the printing system 1000. The ROM 207 stores various control programs including programs for enabling the control unit 205 to execute various processing of later-described flowcharts.

Furthermore, the ROM 207 stores display control programs for enabling the operation unit 204 to perform various displays on its display unit. The control unit 205 reads a program from the ROM 207 and executes the readout program to cause the printing system 1000 to execute various operations described in each exemplary embodiment.

The RAM 208 temporarily stores image data received from the scanner unit 201 or the external I/F unit 202 via the control unit 205, in addition to various programs and setting information.

The HDD 209 is a mass storage device that can store print data of each job as well as control data/variables/information. The control unit 205 receives print data of each job via the input unit (e.g., the scanner unit 201 or the external I/F unit 202) and stores the received print data into the HDD 209. Furthermore, the control unit 205 controls the printer unit 203 to print the print data stored in the HDD 209. Furthermore, the control unit 205 controls the external I/F unit 202 to transmit the print data stored in the HDD 209 to an external apparatus.

The compression/expansion unit 210 performs a compression/expansion operation for the image data stored in the RAM 208 or the HDD 209 according to an appropriate compression method (e.g., JBIG or JPEG).

The control unit 205 controls an operation of the sheet processing apparatus 200 of the inline type. Furthermore, the control unit 205 can output an instruction, via the network 101, to the sheet processing apparatus of the nearline type, such as the paper folding machine 107, the case binding machine 108, and the sheet cutting machine 109.

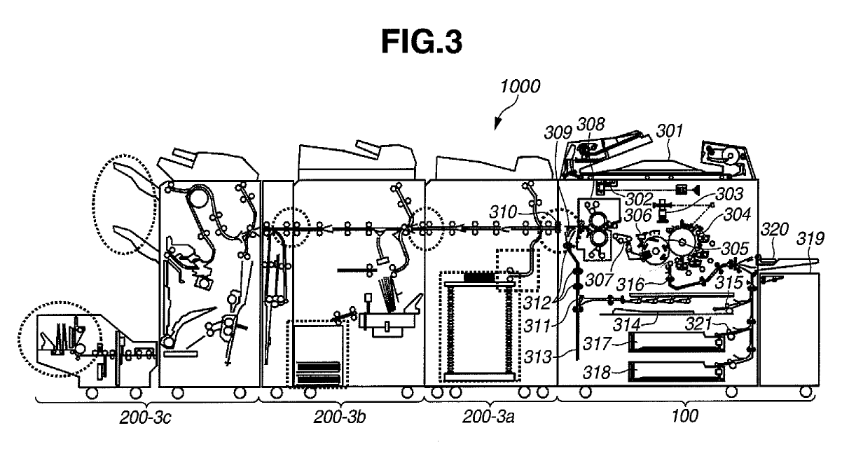

An exemplary mechanical structure of the printing system 1000 is described with reference to a cross-sectional view of FIG. 3. As illustrated in FIG. 3, the printing system 1000 includes a plurality of (an arbitrary number of) inline-type sheet processing apparatuses (200) which are connectable to the printing apparatus 100 and disposed in a predetermined order.

According to an exemplary embodiment illustrated in FIG. 3, three sheet processing apparatuses (200-3a, 200-3b, and 200-3c) are serially connected to the printing apparatus 100. Furthermore, an exemplary configuration of the printing apparatus 100 is described below.

In FIG. 3, a component 301 corresponds to the scanner unit 201 illustrated in FIG. 2. Furthermore, components 302 to 321 correspond to the printer unit 203 illustrated in FIG. 2. According to an exemplary embodiment, the printing apparatus 100 is a 1D type color MFP. Alternatively, the printing apparatus 100 may be a 4D type color MFP or a monochrome MFP.

An auto document feeder (ADF) 301 in FIG. 3 successively separates document sheets stacked in a document tray, from the first page, and conveys each separated document sheet onto a document platen glass. A scanner 302 reads an image of the document on the document platen glass and a charge-coupled device (CCD) converts the read image into image data.

For example, a laser beam or other light is modulated according to the image data and falls on a polygonal mirror 303. The scanning light reflected on a reflection mirror reaches a photosensitive drum 304 and forms a latent image on the photosensitive drum 304. The latent image is developed as a toner image and transferred onto a sheet placed on a transfer drum 305.

The above-described sequential image formation processes are successively executed for yellow (Y), magenta (M), cyan (C), and black (K) toners to finally obtain a full-color image. After completing four-successive image formation processes, a sheet on which a full-color image is formed can be separated from the transfer drum 305 by a separation claw 306 and conveyed to a fixing unit 308 by a pre-fixing carrier 307.

The fixing unit 308 has a predetermined arrangement combining rollers and belts and includes a built-in heat source (e.g., halogen heater) that can melt and fix the toners (toner image) on the sheet material using heat and pressure.

A sheet discharge flapper 309 is configured to swing around a central axis and determine a conveyance direction of a sheet. When the sheet discharge flapper 309 is swung in the clockwise direction in FIG. 3, the sheet is conveyed straight and discharged out of the machine body via sheet discharge rollers 310. On the other hand, the sheet discharge flapper 309 is swung in the counterclockwise direction in FIG. 3 if images are formed on two (front and reverse) faces of a sheet. The sheet advances downward and reaches a two-sided print carrier. The two-sided print carrier includes a reversing flapper 311, reversing rollers 312, a reversing guide 313, and a two-sided tray 314.

The reversing flapper 311 is configured to swing around a central axis and determine a conveyance direction of a sheet. When a two-sided print job is processed, the control unit 205 performs the following control. After an image is formed on a first face of a sheet by the printer unit 203, the control unit 205 causes the reversing flapper 311 to swing in the counterclockwise direction to convey the sheet toward the reversing guide 313 via the reversing rollers 312.

Then, the control unit 205 temporarily stops the reversing rollers 312 in a state where a trailing edge of the sheet material is sandwiched by the reversing rollers 312. Subsequently, the control unit 205 causes the reversing flapper 311 to swing in the clockwise direction and also causes the reversing rollers 312 to rotate in the opposite direction. Thus, the sheet can be conveyed to the two-sided tray 314 in a state where the trailing edge and a leading edge of the sheet are switched.

The two-sided tray 314 temporarily stores the sheet. Then, paper feed rollers 315 guide the sheet toward resist rollers 316. In this case, a second face of the sheet (i.e., a face different from the face subjected to the transfer process of a first page) is positioned to oppose the photosensitive drum 304

Then, similar to the above-described process, an image of second page is formed on the second face of the sheet. As a result, images of two pages are formed on both faces of the sheet. The images on the sheet are subjected to the fixing process. Then, the sheet is discharged out of the machine body via the sheet discharge rollers 310.

By executing the above-described sequential two-sided print processing, the control unit 205 controls the printing apparatus 100 to perform a two-sided print operation for forming images on the first face and the second face of a sheet.

A paper feeding section includes paper feed cassettes 317 and 318 (each having a storage capacity equivalent to 500 sheets), a paper deck 319 (having a storage capacity of 5000 sheets), and a manual feed tray 320, which are operable as a paper feed unit that stores sheets required for the print processing.

Furthermore, paper feed rollers 321 and the resist rollers 316 are provided as a unit for feeding a sheet from the paper feed unit. The paper feed cassettes 317 and 318 and the paper deck 319 can store various sheets which may be different in size and material. Each paper feed unit can store the same type of sheets being classified according to the category.

An exemplary configuration of the sheet processing apparatus 200 (i.e., an inline type sheet processing apparatus included in the printing system 1000) is described below. The sheet printed by the printing apparatus 100 and discharged via the sheet discharge rollers 310 can be conveyed via a sheet conveying path into a mass-storage stacker 200-3a, a gluing bookbinding machine 200-3b, or a saddle stitch binding machine 200-3c.

The mass-storage stacker 200-3a receives printed sheets from the printing apparatus 100 via a sheet conveying path, and stacks the received sheets on a built-in truck that can stock a great amount of sheets.

The paste binding machine 200-3b receives printed sheets (i.e., sheets printed by the printing apparatus 100) from the mass-storage stacker 200-3a via a sheet conveying path, and performs past binding processing for the received sheets.

The saddle stitch binding machine 200-3c receives printed sheets (i.e., sheets printed by the printing apparatus 100) from the paste binding machine 200-3b via a sheet conveying path, and performs saddle stitch binding processing for the received sheets.

Each of the above-described sheet processing apparatuses is equipped with a dedicated paper discharge section. An operator can take out a sheet having been subjected to the sheet processing of each sheet processing apparatus from the paper discharge section of each sheet processing apparatus. The connecting order of the above-described sheet processing apparatuses can be arbitrarily changed as far as the sheet conveying paths are continuously connected.

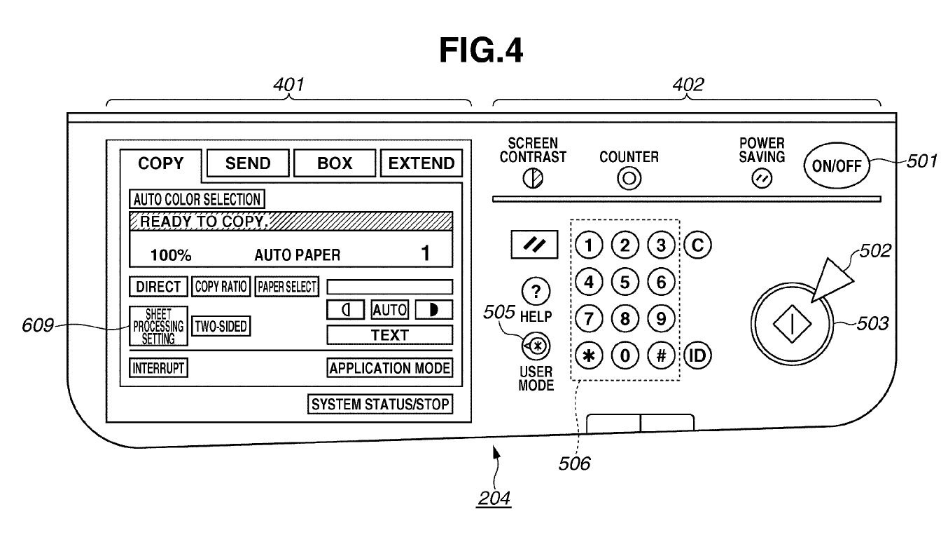

The operation unit 204 of the printing system 1000 is described below with reference to FIG. 4. The operation unit 204 includes a key input unit 402 composed of hard keys, and a touch panel unit 401 composed of software keys (display keys). The operation unit 204 can accept an instruction from a user via the key input unit 402 or the touch panel unit 401.

The key input unit 402 includes a power switch 501, a stop key 502, and a start key 503. The power switch 501 is a key for enabling a user to turn a power source of the printing apparatus 100 on or off. The start key 503 is a key for enabling a user to instruct the printing apparatus 100 to start job processing (e.g., copy, data transmission, etc).

The stop key 502 is a key for enabling a user to instruct the printing apparatus 100 to interrupt the accepted job processing. A numeric keypad (which may be referred to as “ten key”) 506 is a key for enabling a user to input the number of print copies or other various numerical settings in a copy job. A user mode key 505 is a key for enabling a user to display a system setting screen for each user on the touch panel unit 401.

The touch panel unit (hereinafter, referred to as “display unit”) 401 illustrated in FIG. 4 is described below. The display unit 401 includes a liquid crystal display (LCD) unit and a transparent electrode adhered on the LCD unit. An operator can input various setting values of each job via the display unit 401.

For example, if a copy tab of the display unit 401 is pressed by a user, the control unit 205 causes the display unit 401 to display an operation screen relating to a copy function of the printing apparatus 100 (e.g., a screen displayed on the display unit 401 of FIG. 4). A user can perform various settings of a job using a two-sided key, a copy ratio key, and a sheet processing setting key 609 displayed on the copy operation screen of FIG. 4. The sheet processing setting key 609 is a key for enabling a user to perform post-processing settings.

Furthermore, if a transmission (Send) tab is pressed by a user, the control unit 205 causes the display unit 401 to display an operation screen relating to a data transmission (Send) function of the printing apparatus 100, including fax and E-mail transmission. If a box tab is pressed by a user, the control unit 205 causes the display unit 401 to display an operation screen relating to a box function of the printing apparatus 100.

The box function is a function for enabling a user to use a data storage box allocated to each user in the HDD 209 that includes a plurality of data storage boxes (hereinafter, referred to as “box”). According to the box function, the control unit 205 enables a user to select an arbitrary box from the plurality of boxes via the user interface unit and accepts desired operations relating to the selected box from the user.

For example, in response to an instruction received from a user via the operation unit 204, the control unit 205 stores job data received from the scanner 201 of the printing apparatus 100 into the box selected by the user. Furthermore, the control unit 205 stores job data received from the PC 103 via the external I/F unit 202 into a box selected via a user interface unit of the PC 103.

Furthermore, the control unit 205 can control the printer unit 203 to print the job data stored in a box in response to a user instruction via the operation unit 204, in a print format that the user desires. Furthermore, the control unit 205 can transmit job data to the PC 103 or other external information processing apparatus. In this manner, the control unit 205 enables a user to perform various box operations. If the box tab is selected by a user, the control unit 205 causes the display unit 401 to display an operation screen of the box function

The control unit 205 according to an exemplary embodiment executes the following control in the above-described printing system 1000.

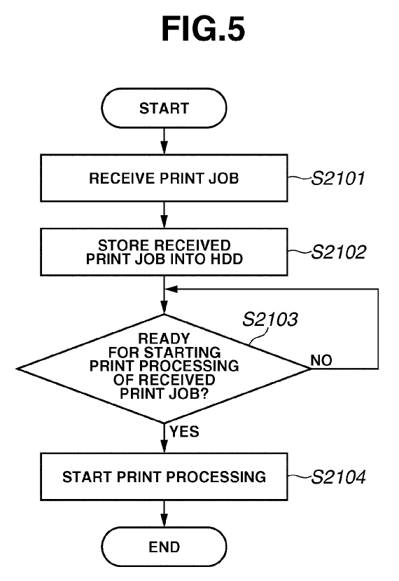

FIG. 5 is a flowchart illustrating a series of operations performed by the control unit 205, starting from accepting a print job and ending by completing print processing of the print job.

In step S2101, the control unit 205 receives a print job which is requested to be printed by the printer unit 203. For example, the control unit 205 receives print data read by the scanner unit 201 via the operation unit 204.

In step S2102, the control unit 205 stores the received print data into the HDD 209. In this case, the control unit 205 can store print conditional information together with the received print job as one print job into the HDD 209.

For example, the print conditional information includes various print settings (or “print conditions”) including the number of print copies, sheet type, and print layout, which can be designated by an operator via the operation unit 204. Furthermore, the control unit 205 can store additional print conditional information (e.g., print density being set using a density setting key, post-processing settings being set using a staple key 701 and a punch key 702) in relation to a print job.

In step S2103, the control unit 205 determines whether the printing system 1000 can start print processing of the received print job. If there is any print job being scheduled to be executed prior to the accepted print job, or if there is any print job being currently executed, the printing system 1000 cannot start print processing of the received print job. Therefore, the control unit 205 prohibits the printer unit 203 from starting the print processing of the received print job.

Namely, the control unit 205 stores this print job into the HDD 209 as a print job waiting for print processing. If in step S2103 the control unit 205 determines that the printing system 1000 can start print processing of the received print job, the processing flow proceeds to step S2104. In step S2104, the control unit 205 instructs the printer unit 203 to start print processing of the print job. In this case, the control unit 205 controls the printer unit 203 to perform print processing of the print job according to print conditional information which is stored in the HDD 209 in relation to the print job.

If there are a plurality of print jobs stored in the HDD 209, the control unit 205 controls the printer unit 203 to start print processing of the plurality of print jobs in principle according to a print request order (i.e., according to an execution priority order). Then, the control unit 205 causes the printer unit 203 to start print processing of a print job to be executed next after completing execution of one print job. As described above, the control unit 205 performs a sequential control described in the flowchart of FIG. 5 when a print job is received.

In a printing system, such as a POD system, an operator may want to continuously perform print processing of a plurality of print jobs (i.e., a great amount of print jobs) which are mutually independent. Furthermore, an operator may want to confirm a finishing state (i.e., print result) of a requested print job stored in the printing system.

In such a case, if the requested print job (i.e., a print job that an operator wants to confirm a finishing state) has a lower execution priority, it takes a long time to output a print product (i.e., printed print data) of the requested print job. Especially, if the printing system holds a great amount of unprocessed print jobs, an operator is required to wait for a long time to confirm a finishing state of a print job having a lower execution priority.

Furthermore, the finishing state of the print job may be different from a desired finishing state due to an operator's setting error or defectiveness of print data. In such a state, an operator is required to restart print processing of the requested print job. This increases a work load of an operator and leads to useless consumption of resources (e.g., recording papers, toners, staple needles, and other consumable stores)

To solve this problem, it is desirable that an operator of the printing system can confirm a finishing state (printed result) of a print job beforehand without waiting for completion of the print processing of the print job

Hence, when there are a plurality of print jobs waiting for print processing, the control unit 205 (i.e., an example of the control unit according to an exemplary embodiment) controls the printer unit 203 to execute “test print processing” (also referred to as “test print”) of a desired job prior to execution of other print jobs waiting for print processing.

The “test print processing” is defined as processing for printing one copy (or a predetermined smaller number of copies) of a print job regardless of a set number of copies designated to a print job. When the printing system performs the test print processing prior to execution of other print jobs waiting for print processing, an operator can confirm a finishing state of a print product of the designated print job before completing print processing of a job to be executed prior to the designated job. Furthermore, processing for printing the set number of copies designated to a print job is referred to as “real print processing” in the following description.

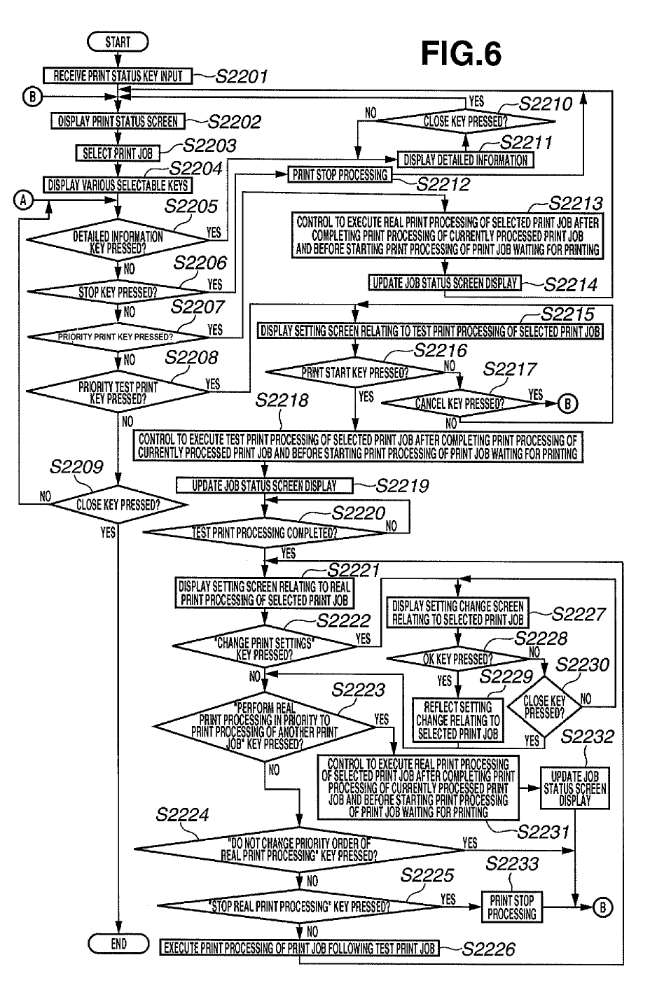

A data processing procedure according to an exemplary embodiment is described below with reference to FIG. 6. FIG. 6 is a flowchart illustrating a first example of data processing procedure performed by the printing system 1000 according to the present invention. The control processing according to the flowchart of FIG. 6 starts when a system status key (which may be referred to as “print status key”) illustrated in FIG. 4 is pressed.

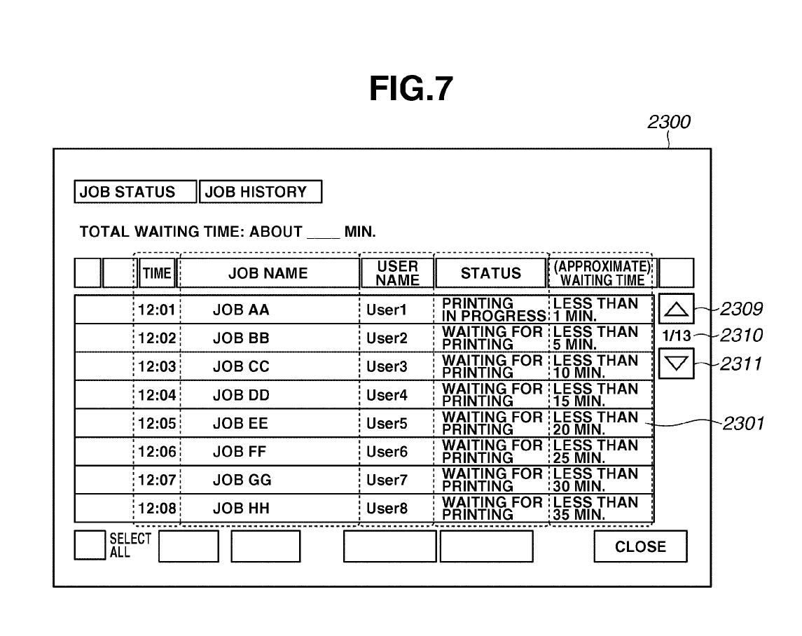

In step S2201 of FIG. 6, if the control unit 205 detects that the system status key of FIG. 4 displayed on the operation unit 204 is pressed, the processing flow proceeds to step S2202. In step S2202, the control unit 205 causes the operation unit 204 to display an operation screen (FIG. 7) that displays a list of job information of print jobs stored in the HDD 209.

In this case, the control unit 205 causes the operation unit 204 to display job information of print jobs stored in the HDD 209 according to a print execution start order (i.e., according to the execution priority order). Therefore, an operator can easily recognize the execution start order of a plurality of mutually independent print jobs displayed on a job list 2301.

FIG. 7 illustrates a job status screen 2300 of job information of the print jobs stored in the HDD 209 displayed on the operation unit 204. A list counter 2310 indicates that the job list 2301 of FIG. 7 is the first page of 13 pages. Furthermore, the job status screen 2300 includes an up-direction key 2309 and a down-direction key 2311. If the down-direction key 2311 is pressed by an operator, the control unit 205 causes the operation unit 204 to display the second page of the job list (i.e., job information of print jobs which are not present in the first page).

The printing system 1000 is configured to enable an operator to select a print job (e.g., an execution object of detailed information display processing or stop processing (which may be referred to as “job cancel”)) via the operation screen of FIG. 7, among the print jobs stored in the HDD 209.

Furthermore, the printing system 1000 is configured to enable an operator to select a print job (e.g., an execution object of priority print processing performed when a “priority print key” is pressed, or priority test print processing performed when a “priority test print key” is pressed).

An exemplary print job selection method is described below. As described above, in step S2202, the control unit 205 causes the operation unit 204 to display the job list 2301 of job information of print jobs stored in the HDD 209. Then, the control unit 205 detects that a desired print job is selected by an operator when the operator touches a display zone of a desired print job in the job list 2301.

Then, if in step S2203 the control unit 205 detects a print job selected by an operator, the control unit 205 performs a highlight display of job information corresponding to the selected print job on the job list 2301.

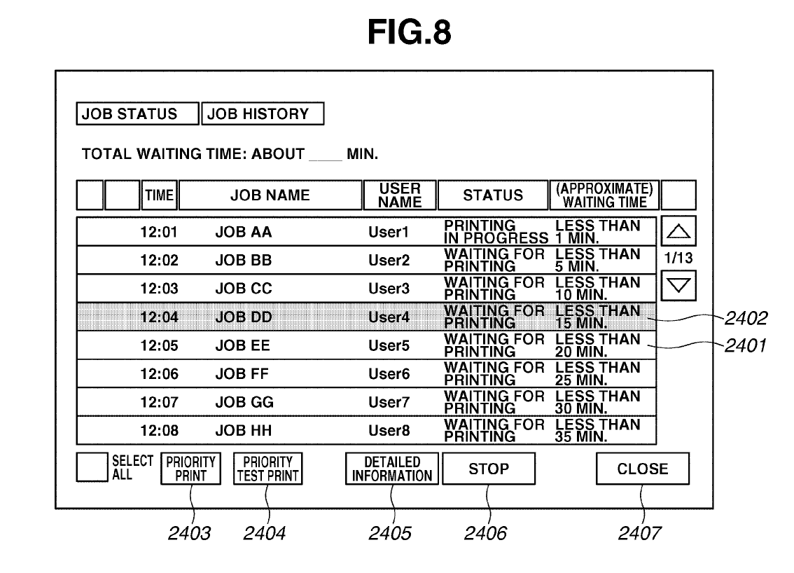

FIG. 8 illustrates the first page of a job list 2401 which describes job information of a total of eight print jobs (print job AA to print job HH) according to a print execution start order (according to an execution priority order), selected from the print jobs stored in the HDD 209 and mutually independent from each other.

For example, if the control unit 205 detects that a print job DD is selected by an operator who touches a display zone of the print job DD in a state where the screen of FIG. 8 is displayed, the control unit 205 causes the operation unit 204 to perform a highlight display of the display zone of the print job DD as illustrated in FIG. 8. Therefore, an operator can easily confirm that selection of the print job DD is accepted. Furthermore, the control unit 205 cancels the selection (highlight display) of a print job selected by an operator if the operator again presses the display zone of the print job.

If an operator does not select any print job as illustrated in FIG. 7, the control unit 205 displays a detailed information key 2405 and a stop key 2406 in an unselectable state using a gray-out method. Similarly, in the state of FIG. 7, the control unit 205 displays a priority print key 2403 and a priority test print key 2404 in an unselectable state.

If the control unit 205 detects that the print job DD is selected, the processing flow proceeds to step S2204 from step S2203. The control unit 205 performs a highlight display of a display zone of the print job DD as illustrated in FIG. 8 and performs the following control.

The control unit 205 causes the operation unit 204 to display the detailed information key 2405, the stop key 2406, the priority print key 2403, and the priority test print key 2404 in a selectable state.

If any one of the detailed information key 2405, the stop key 2406, the priority print key 2403, and the priority test print key 2404 is pressed, the control unit 205 performs the following control. If in step S2205 the control unit 205 detects that the detailed information key 2405 is pressed in a state where the print job DD is selected, the processing flow proceeds to step S2211.

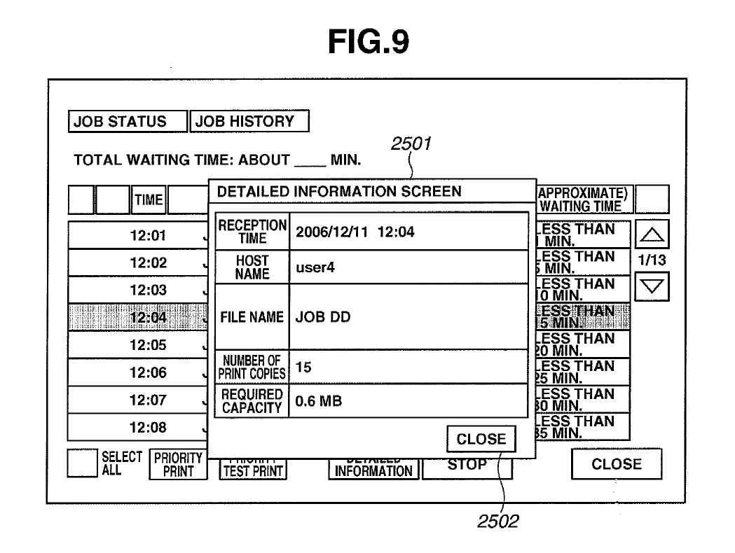

In step S2211, the control unit 205 causes the operation unit 204 to display a detailed information screen 2501 of the print job DD as illustrated in FIG. 9. The screen may include a print setting change key that enables a user to change the number of print copies or settings relating to post-processing or print settings of a job.

If the control unit 205 detects that a close key 2502 on the detailed information screen 2501 is pressed in step S2210, the processing flow returns to step S2202. In step S2202, the control unit 205 causes the operation unit 204 to display the operation screen (FIG. 7) that displays the list of job information of print jobs stored in the HDD 209.

If in step S2205 the control unit 205 determines that the detailed information key is not pressed, the processing flow proceeds to step S2206. In step S2206, the control unit 205 determines whether the stop key 2406 is pressed. If in step S2206 the control unit 205 detects that the stop key 2406 is pressed in a state where the print job DD is selected, the control unit 205 performs print stop processing (S2212) for the print job DD.

More specifically, the control unit 205 deletes the print job DD from the HDD 209 and also deletes the job information of the print job DD from the job list 2301. Then, the processing flow proceeds to step S2202, in which the control unit 205 causes the operation unit 204 to display the operation screen (FIG. 7) that displays the list of job information of print jobs stored in the HDD 209. Then, the processing flow proceeds to step S2207.

If in step S2207 the control unit 205 detects that the priority print key 2403 is pressed in a state where the print job DD is selected, the control unit 205 performs control for increasing the execution priority order of the print job DD.

For example, if in step S2207 the control unit 205 detects that the priority print key 2403 is pressed in a state where the print job DD to be executed after the print job CC is selected as illustrated in FIG. 8, the processing flow proceeds to step S2213.

In step S2213, the control unit 205 performs the following control. The control unit 205 performs control to execute real print processing of the print job DD after completing the print processing of the currently processed print job AA and before starting print processing of the print job BB waiting for print processing. As described previously, the real print processing is to perform print processing in response to a print request for the set number of copies designated by an operator.

On the other hand, the test print processing is to perform print processing for a limited number of copies. In this case, the control unit 205 prevents the printer unit 203 from executing test print processing of the print job DD after completing print processing of the currently processed print job AA and before starting print processing of the print job BB waiting for print processing. Then, the processing flow proceeds to step S2214.

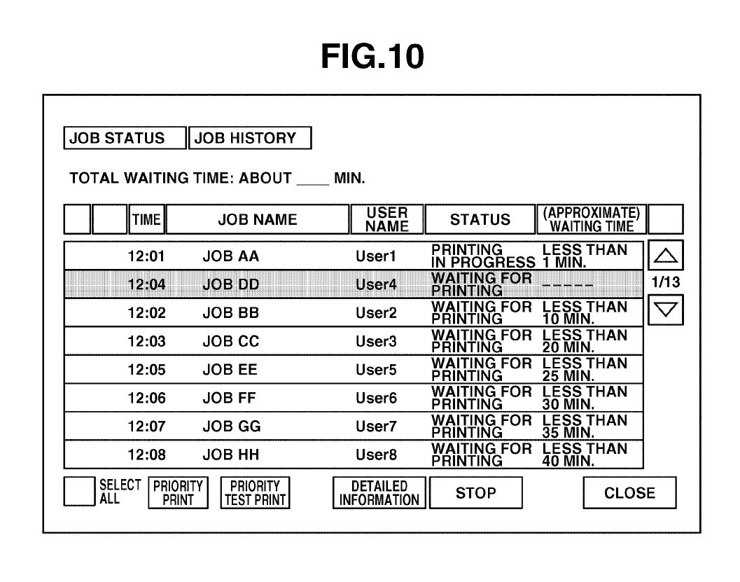

In step S2214, the control unit 205 causes the operation unit 204 to update the display of the job status screen 2300. More specifically, the control unit 205 causes the operation unit 204 to display a job status screen illustrated in FIG. 10 so that a user can confirm that real print processing of the print job DD is scheduled to start after completing print processing of the currently processed print job AA and before executing print processing of the print job BB waiting for print processing.

In other words, the control unit 205 causes the operation unit 204 to display job information of the print job DD which is interposed between job information of the print job AA and job information of the print job BB.

Then, the control unit 205 causes the printer unit 203 to start real print processing of the print job DD after completing the print processing of the print job AA. Therefore, an operator can obtain a print product of the print job DD without waiting completion of the print processing of the print job BB and the print job CC.

If in step S2207 the control unit 205 determines that a priority print key 2403 is not pressed in a state where the print job DD is selected, the processing flow proceeds to step S2208. In step S2208, the control unit 205 determines whether the priority test print key 2404 is pressed. If in step S2208 the control unit 205 determines that the priority test print key is not pressed, the processing flow proceeds to step S2209. In step S2209, the control unit 205 determines whether a close key 2407 is pressed. If in step 2209 the control unit 205 determines that the close key 2407 is not pressed, the processing flow proceeds to step S2205. On the other hand, if in step 2209 the control unit 205 determines that the close key 2407 is pressed, the control unit 205 finishes processing indicated in the processing flow.

If the control unit 205 detects that the priority test print key 2404 is pressed in a state where the print job DD is selected, the control unit 205 controls the printer unit 203 to perform test print processing of the print job DD prior to execution of other job in a print wait state.

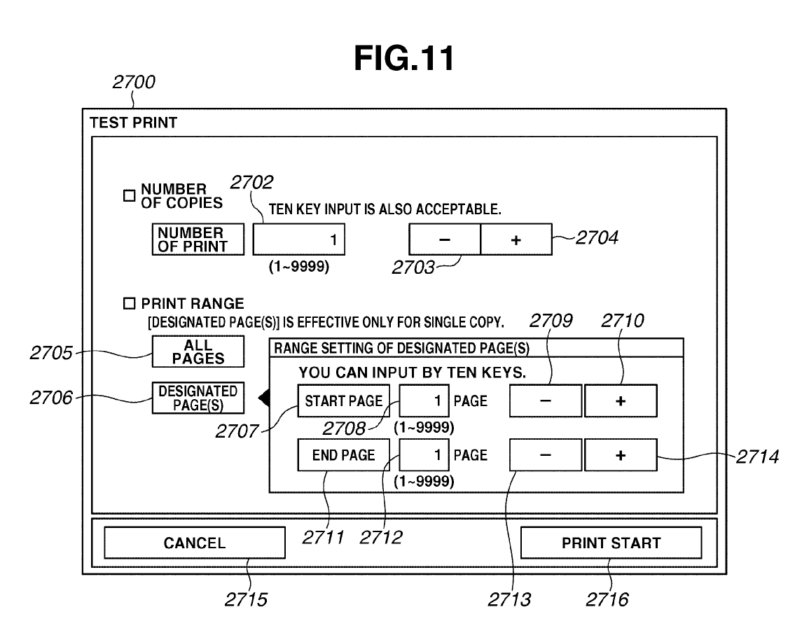

First, if in step S2208 the control unit 205 detects that the priority test print key 2404 is pressed in a state where the print job DD is selected, the processing flow proceeds to step S2215. In step S2215, the control unit 205 causes the operation unit 204 to display a test print setting screen 2700 illustrated in FIG. 11. According to the default settings illustrated in FIG. 11, the control unit 205 executes one copy of test print processing of a selected job.

The printing system 1000 is configured to enable an operator to designate the number of copies in the test print processing according to the following method. If in the default settings of FIG. 11 a print start key 2716 is pressed, the control unit 205 causes the printer unit 203 to produce one copy of test print processing according to a value displayed in a copy number display field 2702.

In the display screen of FIG. 11, if a copy number increment key 2704 is pressed by a user, the control unit 205 successively increments the number of copies (i.e., the number of print products) to be output as a result of test print processing. Furthermore, if the control unit 205 detects that the copy number increment key 2704 is pressed, the control unit 205 successively increments the value displayed in the copy number display field 2702.

The control unit 205 acquires a designated number of copies for a print job (i.e., an execution object of test print processing) from print conditional information of the print job. The control unit 205 sets the designated number of copies as upper limit value. Alternatively, the control unit 205 can set a small value (e.g., three copies or five copies) as upper limit value. When the upper limit value is small, the test print processing of the print job does not take a long time. Therefore, the printer unit 203 can promptly start print processing of other print job.

Furthermore, if the control unit 205 detects that a copy number decrement key 2703 is pressed, the control unit 205 successively decrements the number of copies (i.e., the number of print products) to be output as a result of test print processing. In this case, the control unit 205 can successively decrement a value displayed in the copy number display field 2702. Moreover, the control unit 205 can set the number of copies (i.e., the number of print products) according to an operator's input via the numeric keypad 506.

Furthermore, according to the default settings, the control unit 205 controls the printer unit 203 to execute test print processing for all pages of a selected job. More specifically, if the control unit 205 detects that the print start key 2716 is pressed in the default state illustrated in FIG. 11, the control unit 205 controls the printer unit 203 to perform test print processing of all pages of a job (i.e., an execution object of test print processing).

However, the printing system 1000 is configured to allow an operator to designate a page to be subjected to the test print processing according to the following method. If the control unit 205 detects that a designation page key 2706 is pressed, the control unit 205 cancels the highlight display of an all page key 2705 and performs a highlight display of the designation page key 2706.

Then, the control unit 205 causes the operation unit 204 to display various keys 2707 to 2714 in a selectable state. If the control unit 205 detects that the start page key 2707 is pressed in a state where the designation page key 2706 is selected, the control unit 205 executes a highlight display of the start page key 2707 so that an operator can recognize that the start page key 2707 is selected.

If the control unit 205 detects that a start page increment key 2710 is pressed in a state where the start page key 2707 is selected, the control unit 205 successively increments the execution start page of the test print processing by one. If the control unit 205 detects that the start page increment key 2710 is pressed, the control unit 205 successively increments a value in the start page display field by one. Thus, an operator can recognize a page number from which the control unit 205 (the printer unit 203) starts test print processing.

If the control unit 205 detects that a start page decrement key 2709 is pressed, the control unit 205 successively decrements the execution start page of the test print processing by one. In this case, the control unit 205 successively decrements a value in an end page number display field 2712 by one.

Furthermore, the control unit 205 can directly accept the number of start page to be output as a result of test print processing, if instructed by an operator using the numeric keypad 506 in a state where the start page key 2707 is selected. The lower limit value of the start page is set to 1. The upper limit value of the start page is equal to an end page of a job (i.e., an execution object of test print processing).

Furthermore, when the operation unit 204 displays the test print setting screen 2700 illustrated in FIG. 11, the control unit 205 executes print processing of a requested print job stored in the HDD 209 without any interruption. Thus, the productivity of the entire system can be maintained without stopping print processing of the printing apparatus.

It is now assumed that the print start key 2716 is pressed by an operator, after one copy of a test print including all pages of the print job DD is designated on the test print setting screen illustrated in FIG. 11.

If in step S2216 the control unit 205 detects that the print start key 2716 is pressed, the processing flow proceeds to step S2218. In step S2218, the control unit 205 generates a test print job DD of the print job DD. Then, the control unit 205 stores the generated test print job DD into the HDD 209. The control unit 205 controls the printer unit 203 to execute test print processing of the test print job DD after completing the currently processed print job AA and before starting print processing of the print job BB waiting for print processing.

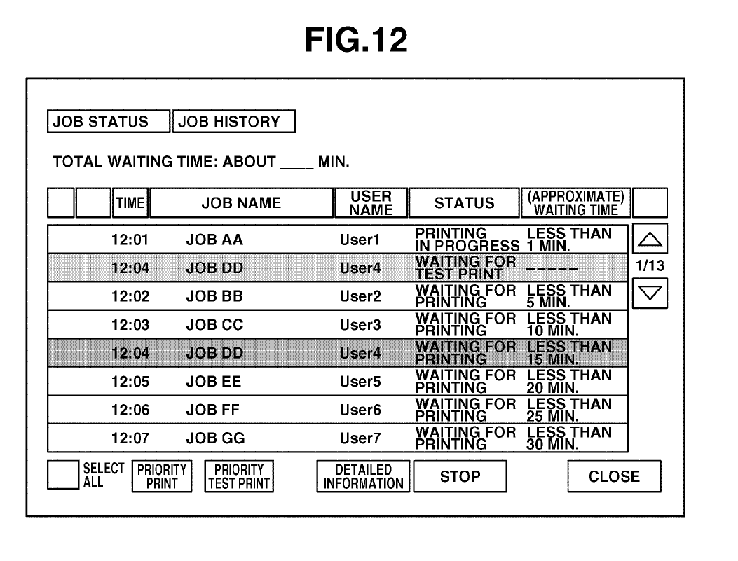

Then, in step S2219, the control unit 205 performs the following control. The control unit 205 causes the operation unit 204 to display a job status screen illustrated in FIG. 12 so that a user can recognize that the test print processing of the print job DD starts after completing the print processing of the currently processed print job AA and before starting print processing of the print job BB waiting for print processing.

As illustrated in FIG. 12, the control unit 205 causes the operation unit 204 to display a message “test print waiting” in a status field of the display zone of the test job information of the print job DD. Thus, a user can recognize that the test print job DD is an object of the test print processing (not an object of the real print processing). In other words, the control unit 205 causes the operation unit 204 to display the message “test print waiting” so that a user can discriminate the real print processing of the job DD and the test print processing of the job DD displayed on the operation unit 204.

Then, the control unit 205 controls the printer unit 203 to start test print processing of the test print job DD after completing the print processing of the print job AA. If the print start key 2716 is not pressed (NO in step S2216) and a cancel key 2715 is pressed (YES in step 2217), the control unit 205 returns to step S2202.

In step S2202, the control unit 205 causes the operation unit 204 to display the operation screen (FIG. 7) that displays the list of job information of print jobs stored in the HDD 209. If in step S2217 the cancel key 2715 is not pressed, the processing flow returns to step S2215. In step S2215, the control unit 205 causes the operation unit 204 to continuously display the test print setting screen 2700 relating to the settings of the test print processing of a selected print job.

According to the above-described control, the printing apparatus 100 of the printing system 1000 can execute test print processing of any following print job (i.e., the print job DD according to the above-described example) prior to execution of a print waiting job (i.e., the print job BB and the print job CC according to the above-described example). Thus, an operator can promptly confirm a print result of the following job (i.e., the print job DD).

The control unit 205 controls the printer unit 203 to successively execute print processing of the print job BB and the print job CC after completing test print processing of the test print job DD and before starting real print processing of the print job DD.

Through the above-described processing, an operator can confirm a print result (i.e., a print product) generated by the execution of the test print processing. If in step S2220 the control unit 205 determines that the print processing of test print job DD has been completed, the control unit 205 performs processing of steps S2221 to S2225 to accept an instruction from an operator with respect to real print processing.

For example, an operator can select, via the operation unit 204, an operation for causing the printer unit 203 to perform the real print processing prior to execution of other jobs waiting for print processing after completing test print processing, or an operation for causing the printer unit 203 to execute real print processing without changing the priority order of the real print processing.

Furthermore, an operator can change settings relating to the real print processing via the operation unit 204, if a print result (product) of the test print processing is different from a desired finishing state due to operator's setting error. Furthermore, an operator can input an instruction for stopping the real print processing via the operation unit 204, if a print result (product) of the test print processing is different from a desired finishing state due to the defectiveness of print data.

Next, exemplary processing performed after completing print processing of the generated test print job DD is described below.

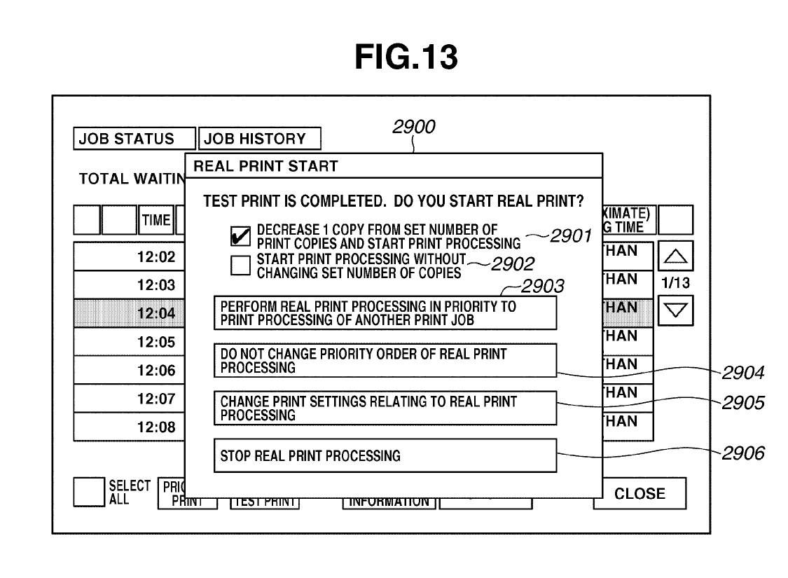

If in step S2220 the control unit 205 determines that the print processing of the test print job DD generated in step 2218 is completed, the processing flow proceeds to step S2221. In step S2221, the control unit 205 causes the operation unit 204 to display a setting screen 2900 illustrated in FIG. 13 which relates to real print processing of the selected print job DD.

If an operator instructs performing real print processing in the state of FIG. 13 where a “decrease 1 copy from set number of print copies and start print processing” 2901 is selected on the setting screen 2900, the control unit 205 performs the following control. The control unit 205 controls the printer unit 203 to execute real print processing of the selected print job DD by decreasing one (i.e., the number of print copies already printed for the test print processing) from the set number of print copies.

For example, when the test print processing is performed, the control unit 205 stores the number of print copies performed for the test print processing into the RAM 208. Then, the control unit 205 subtracts the number of print copies having been printed for the test print processing from the set number of print copies designated in the print conditional information stored in the HDD 209 in relation to the print job DD. The control unit 205 newly sets the obtained number of print copies as print conditional information in relation to the print job DD.

Then, the control unit 205 controls the printer unit 203 to execute real print processing of the print job DD while the number of print copies is decreased by the number already generated by the execution of the test print processing for the print job DD. Thus, an operator can use the print product generated by the test print processing as part of the real output result. As a result, papers can be effectively prevented from being consumed uselessly.

On the other hand, if an operator instructs performing real print processing in a state where a “start print processing without changing set number of copies” 2902 is selected on the setting screen 2900, the control unit 205 performs the following control. The control unit 205 controls the printer unit 203 to execute real print processing of the selected print job DD, without changing the number of print copies designated for the print job DD. The printer unit 203 generates the designated number of print copies.

Thus, even if a print product is output to an output destination in a state where a print product of any other print job is present between a print product of the test print processing of a print job and a print product of the real print processing of this print job, an operator can obtain an output print product (i.e., the designated number of print copies) through the real print processing.

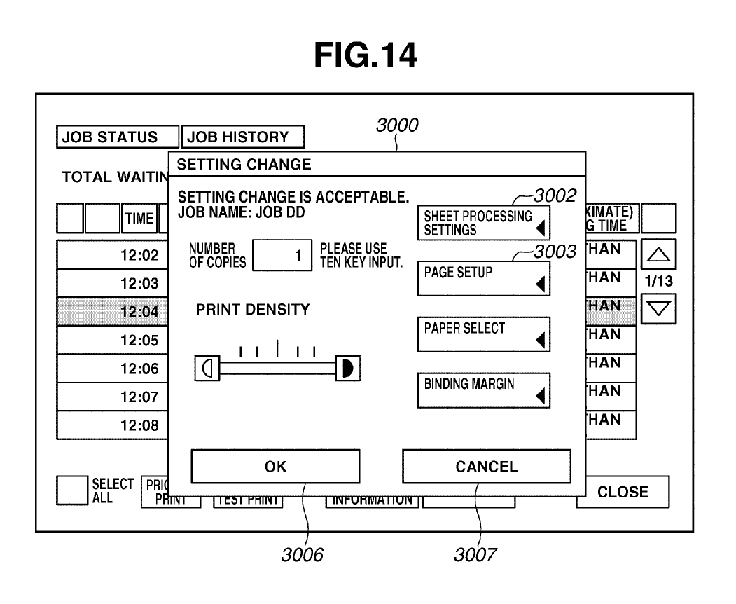

Then, in step S2221, the control unit 205 causes the operation unit 204 to display the setting screen 2900 illustrated in FIG. 13 which relates to real print processing of the selected print job DD. Then, the processing flow proceeds to step S2222. If in step S2222 the control unit 205 detects that a “change print settings relating to real print processing” key 2905 is pressed, the processing flow proceeds to step S2227. In step S2227, the control unit 205 causes the operation unit 204 to display a screen 3000 (FIG. 14) that enables a user to change print settings relating to the real print processing of the print job DD.

For example, in a state where the screen of FIG. 14 is displayed, the control unit 205 accepts a change in the number of print copies being set for the selected print job DD which is input by an operator via the numeric keypad 506. Furthermore, if the control unit 205 detects that a sheet processing setting key 3002 is pressed, the control unit 205 accepts a change in the type of sheet processing to be executed for the print job DD.

Furthermore, if the control unit 205 detects that a page setting key 3003 is pressed, the control unit 205 causes the operation unit 204 to display a screen (not illustrated) that enables an operator to change various page settings (e.g., layout of page, print copy ratio, and print orientation) relating to the print job DD. Similarly, the control unit 205 allows an operator to change other settings (e.g., print density, sheet type, and binding margin) via the operation unit 204. Then, the processing flow proceeds to step S2228.

If in step S2228 the control unit 205 detects that an OK key 3006 is pressed, the processing flow proceeds to step S2229. In step S2229, the control unit 205 changes the print settings of the print job DD so as to reflect the print settings having been changed by an operator. In other words, the control unit 205 rewrites the data stored in the HDD 209 (the print conditional information stored in relation to the print job DD) with information including setting changes, based on the print settings having been changed by an operator. Then, the processing flow proceeds to step S2223.

Furthermore, if in step S2228 the OK key 3006 is not pressed, the processing flow proceeds to step S2230. If in step S2230 the control unit 205 detects that a cancel key 3007 is pressed, the processing flow proceeds to step S2223 without reflecting the print settings having been changed by an operator through the setting screen 2900 in the print settings of the print job DD.

In step S2223, the control unit 205 determines whether a “perform real print processing prior to print processing of other print job” key 2903 is pressed. If in step S2223 the control unit 205 determines that the “perform real print processing prior to print processing of other print job” key 2903 is not pressed, the processing flow proceeds to step S2224.

If in step S2223 the control unit 205 detects that the “perform real print processing prior to print processing of other print job” key 2903 is pressed, the processing flow proceeds to step S2231. In step S2231, the control unit 205 performs the following control. More specifically, the control unit 205 controls the printer unit 203 to execute real print processing of the selected print job DD after completing the currently performed print job (i.e., the print job BB) and before starting print processing of a print job waiting for print processing (i.e., print job CC).

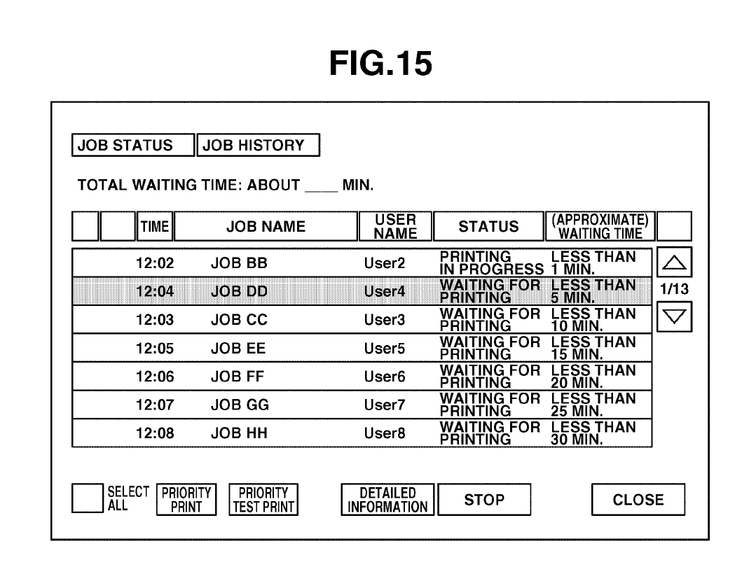

Then, in step S2232, the control unit 205 performs the following control. The control unit 205 causes the operation unit 204 to display a job status screen of FIG. 15. Thus, a user can recognize that real print processing of the print job DD starts after completing print processing of the currently processed print job BB and before starting print processing of the print job CC waiting for print processing. Then, the processing returns to step S2202 to cause the operation unit 204 to display a print status screen illustrated in FIG. 15.

Then, the control unit 205 controls the printer unit 203 to execute print processing of the print job DD after completing print processing of the print job BB. Therefore, an operator can obtain a print product of the print job DD without waiting completion of the print processing of the print job CC. In this manner, the control unit 205 controls the printer unit 203 to execute both the test print processing of the print job DD and the real print processing of the print job DD prior to execution of other print jobs. In this case, the control unit 205 first executes the test print processing of the print job DD and then executes the real print processing of the print job DD.

In step S2224, the control unit 205 determines whether a “do not change priority order of real print processing” key 2904 is pressed. If in step S2224 the control unit 205 determines that the “do not change priority order of real print processing” key 2904 is not pressed, the processing flow proceeds to step S2225.

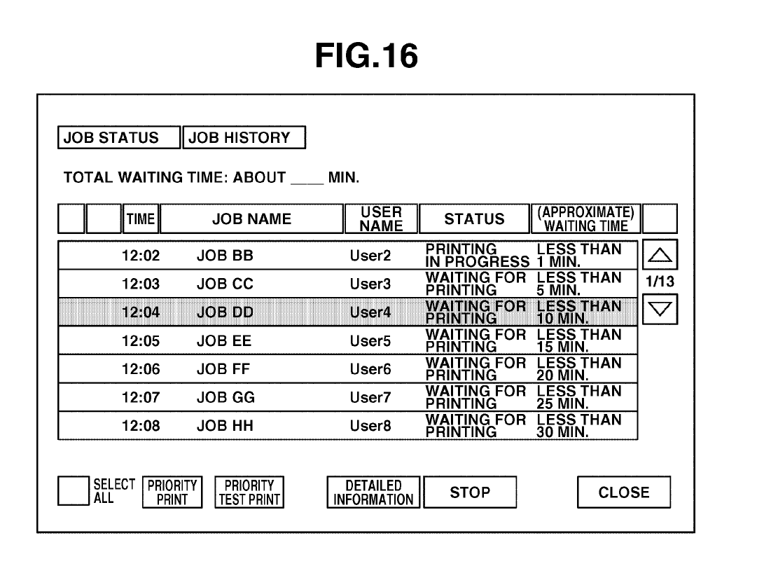

If in step S2224 the control unit 205 detects that the “do not change priority order of real print processing” key 2904 is pressed, the control unit 205 performs the following control without changing the execution priority order of the print job DD. The processing flow proceeds to step S2202 to cause the operation unit 204 to display the print status screen of FIG. 16.

If in step S2225 the control unit 205 detects that a “stop real print processing” key 2906 is pressed, the processing flow proceeds to step S2233. In step S2233, the control unit 205 executes print stop processing for the print job DD. For example, the control unit 205 deletes the print job DD from the HDD 209 and also deletes the job information of the print job DD from the job list 2301. Then, the processing flow returns to step S2202.

The control unit 205 causes the operation unit 204 to display an operation screen displaying a list of job information of print jobs stored in the HDD 209. Namely, the control unit 205 performs control to prohibit an operator from performing real print processing of the print job DD.

Thus, an operator can confirm a print result (product) generated by executing the test print processing of a print job and can stop the real print processing of this print job if the test print result is different from a desired finishing state.

If in step S2225 the control unit 205 detects that the “stop real print processing” key 2906 is not pressed, the processing flow proceeds to step S2226. In step S2226, the control unit 205 controls the printer unit 203 to start print processing of a print job executable after completing the test print processing of the print job DD.

According to an exemplary embodiment, the printer unit 203 starts print processing of the print job BB after completing the test print processing of the print job DD, and starts print processing of the print job CC after completing the print processing of the print job BB.

For example, if the print processing of the print job BB and the print job CC is completed in a state where the real print setting screen for the print job DD illustrated in FIG. 13 is displayed, the control unit 205 can start real print processing of the print job DD even if the settings relating to the real print processing of the print job DD are not accepted.

In this case, the control unit 205 can perform the following controls.

(1) The control unit 205 controls the printer unit 203 to start print processing of a print job EE and a print job FF (i.e., print jobs following the print job DD) without temporarily stopping the print processing of the image forming apparatus. Thus, the productivity of the entire system can be appropriately maintained.

(2) The control unit 205 controls the image forming apparatus to temporarily stop print processing until the setting changes relating to the real print processing of the print job DD by an operator are accepted. In this case, the control unit 205 can prevent print processing of any following job from being performed prior to the print processing of the print job DD. Thus, the control unit 205 enables an operator to change settings relating to the real print processing of the print job DD without changing the output order of the jobs.

(3) The control unit 205 terminates the screen display illustrated in FIG. 13 and starts real print processing of the print job DD. Therefore, the control unit 205 can prevent the printing apparatus 100 from temporarily stopping the print processing, without changing the output order of print jobs. Thus, the productivity of the entire system can be maintained appropriately.

Furthermore, when the screen display illustrated in FIG. 13 is terminated, the control unit 205 can cause the operation unit 204 to display a confirmation message (e.g., “The print job DD is ready to start printing. Do you start printing?”), thereby allowing an operator to instruct starting of the real print processing of the print job DD.

If the control unit 205 detects that a “YES” key is pressed by an operator, the control unit 205 controls the printer unit 203 to start real print processing of the print job DD. On the other hand, if the control unit 205 detects that a “NO” key (i.e., a key for prohibiting real print processing of the print job DD from starting) is pressed by an operator, the control unit 205 controls the printer unit 203 to start print processing of the job print job EE and the print job FF following the print job DD. Thus, the control unit 205 can execute a control reflecting an operator's intent.

Furthermore, the control unit 205 can select one of the above-described controls (1) to (3) according to, for example, a user mode.

According to the above-described controls, the printer unit 203 performs a test print of any following print job (i.e., a print job scheduled to be executed later) prior to execution of other print jobs, even if a large number of unprocessed print jobs are present in the printing system. Therefore, an operator can confirm a print result (product) of any succeeding job without a long waiting time.

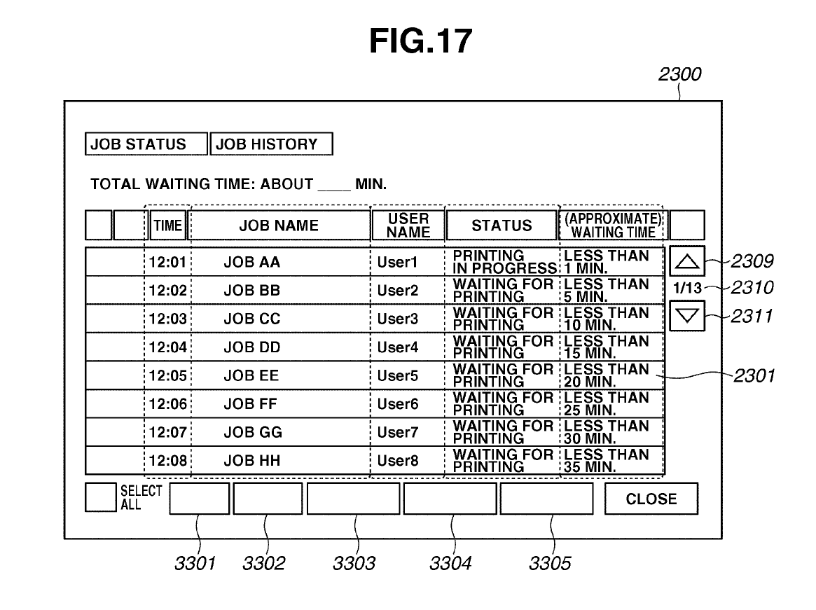

The job status screen used is not limited to the screen illustrated in FIG. 7. According to another exemplary embodiment, the control unit 205 causes the operation unit 204 to display an operation screen illustrated in FIG. 17.

As illustrated in FIG. 17, the control unit 205 causes the operation unit 204 to display a test-only priority print key 3302 in addition to the priority print key 3301 and a priority test print key 3303.

If the control unit 205 detects that a priority print key 3301 is pressed via the screen illustrated in FIG. 17 in a state where the print job DD is selected, the control unit 205 performs a control similar to the control performed when the control unit 205 detects that the priority print key 3402 is pressed in step S2207 of FIG. 6.

Furthermore, if the control unit 205 detects that the priority test print key 3303 is pressed via the screen illustrated in FIG. 17 in a state where the print job DD is selected, the control unit 205 performs the following control. The control unit 205 performs a control similar to the control performed when the control unit 205 detects that the priority test print key 2404 is pressed in step S2208 of FIG. 6.

If the control unit 205 detects that the test-only priority print key 3302 is pressed in a state where the screen illustrated in FIG. 17 is displayed and the print job DD is selected, the control unit 205 causes the operation unit 204 to display a setting screen relating to test print processing of the print job DD illustrated in FIG. 11. Then, if the control unit 205 detects that the print start key 2716 is pressed, the control unit 205 performs the following control based on the conditions being set via the screen of FIG. 11.

The control unit 205 controls the printer unit 203 to execute test print processing of the print job DD after completing print processing of the currently processed print job AA and before starting print processing of the print job BB waiting for print processing. Then, the control unit 205 causes the operation unit 204 to display a job status screen of FIG. 12, so that a user can recognize that print processing of the print job DD starts after completing print processing of the currently processed print job AA and before starting print processing of the print job BB waiting for print processing.

However, a control performed when the test-only priority print key 3302 is pressed is different from the control performed when the priority test print key 2404 is pressed in that the operation unit 204 does not display a setting screen relating to the real print processing even after completing the test print processing of the print job DD.

In this manner, when a key for performing only the test print processing is provided in the operation unit 204, an operator can perform test print processing of a selected print job with a simple operation.

In the above-described control, only one job is selected by an operator via the screen illustrated in FIG. 7 or FIG. 17. Furthermore, the printing system 1000 can be configured to enable an operator to select a plurality of print jobs from the HDD 209 via the operation unit 204.

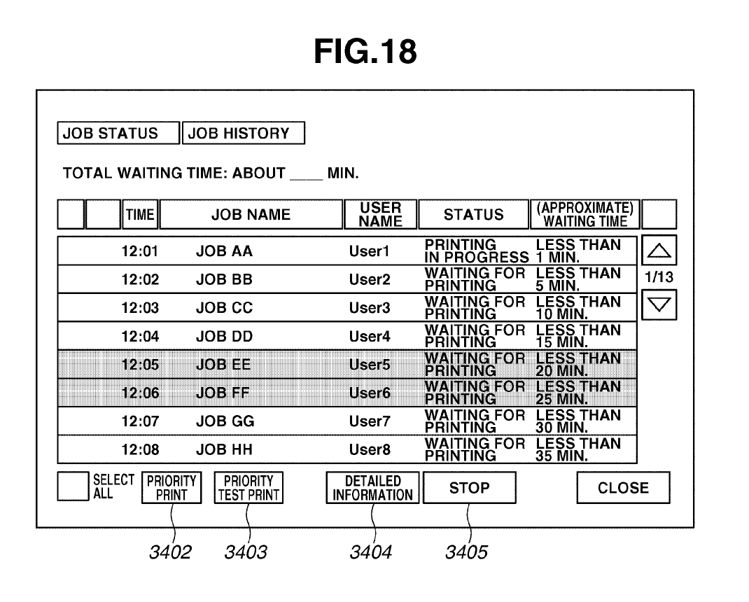

For example, if the control unit 205 detects that an operator presses a display zone of the print job EE and a display zone of the print job FF in a state where the screen illustrated in FIG. 7 is displayed, the control unit 205 performs a highlight display of the display zones of the print job EE and print job FF as illustrated in FIG. 18.

Therefore, an operator can easily recognize that both the print job EE and the print job FF are selected. Furthermore, if an operator again presses the display zone of the currently selected print job (i.e., highlighted display zone), the control unit 205 causes the operation unit 204 to cancel the selection of the pressed print job.

In this manner, the printing system 1000 enables an operator to select a plurality of print jobs. For example, an operator can simply instruct stopping the print processing of the selected plurality of print jobs.

However, if the print processing of a plurality of print jobs is cancelled, for example, if the execution priority orders of a plurality of print jobs are raised, the execution order of the jobs may be greatly changed compared to the original order designated by an operator. If the execution order is greatly changed, execution of a print job to which an operator has allocated a higher priority may be delayed.

For example, in the POD market, execution of a print job may not be completely finished before its due date. More specifically, in the POD market, it may be possible to separately perform the print processing. However, in this case, a person who requests a print job may be different from a person who manages the maintenance (supply of sheets and toners) of the printing system.

For example, a person who requests a print job schedules transmission of the print job to the printing system considering a due date being set for the job. However, if another person who manages an operation of the printing system greatly changes the execution priority order of the print jobs, execution of a requested print job may be delayed undesirably. Thus, it is desirable that each print job can be surely finished before its due date.

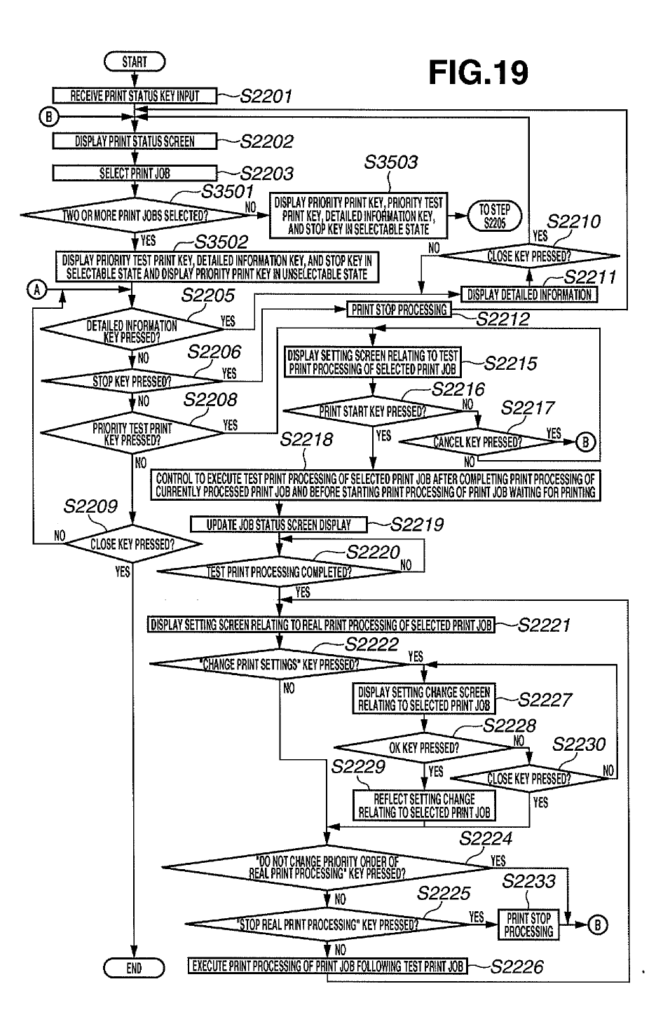

An exemplary control performed by the control unit 205 to satisfy the above-described requirement is described with reference to a flowchart of FIG. 19. The flowchart of FIG. 19 includes steps similar to those described in FIG. 6. Therefore, the same step numbers are used and the same step will not be described below.

If in step S2201 the control unit 205 detects that the system status key is pressed, the processing flow proceeds to step S2202. In step S2202, the control unit 205 causes the operation unit 204 to display the print status screen illustrated in FIG. 7. If in step S2203 the control unit 205 detects that any print job is selected by an operator via the operation unit 204, processing flow proceeds to step S3501.

In step S3501, the control unit 205 determines whether two or more jobs are selected. If the control unit 205 determines that only one job is selected, the processing flow proceeds to step S3503. In step S3503, the control unit 205 causes the operation unit 204 to display a priority print key 3402, a priority test print key 3403, a detailed information key 3404, and a stop key 3405 in a selectable state.

Then, the processing flow proceeds to step S2205 to perform a control similar to that illustrated in FIG. 6. The control unit 205 performs the processing of step S2205 and succeeding processing illustrated in FIG. 6 for the selected print job. If the processing flow proceeds to B(step S2202), the control unit 205 repeats the above-described processing of step S3501.

On the other hand, if in step S3501 the control unit 205 determines that two or more print jobs are selected, the processing flow proceeds to step S3502. In step S3502, the control unit 205 causes the operation unit 204 to display the priority test print key 3403, the detailed information key 3404, and the stop key 3405 in a selectable state and also display the priority print key 3402 in an unselectable state.

Namely, the control unit 205 allows an operator to perform test print processing of the selected print jobs prior to execution of other print jobs. Furthermore, the control unit 205 prohibits an operator from executing real print processing of the selected print jobs prior to execution of other print jobs.

It is now assumed that an operator selects the print job EE and the print job FF on the screen of FIG. 7. In step S2203 of FIG. 19, the control unit 205 detects that the print job EE and the print job FF are selected. Then, in step S3501, the control unit 205 determines that two or more print jobs are selected. The processing flow proceeds to step S3502.

In step S3502, the control unit 205 performs a highlight display of the print job EE and the print job FF as illustrated in FIG. 18. Furthermore, the control unit 205 causes the operation unit 204 to display the priority test print key 3403, the detailed information key 3404, and the stop key 3405 in a selectable state and display the priority print key 3402 in an unselectable state.

If in step S2205 the control unit 205 detects that the detailed information key 3404 is pressed, the control unit 205 causes the operation unit 204 to display information relating to the print job EE and the print job FF in step S2210. In this case, the display format for displaying the detailed information of the print job EE and the print job FF is not limited.

For example, when the number of selected print jobs is relatively small, the control unit 205 can cause the operation unit 204 to display detailed information of a plurality of print jobs on the same screen. Furthermore, when the number of selected print jobs is relatively large, the control unit 205 can cause the operation unit 204 to display detailed information of one print job on the first page and display detailed information of another print job each time a “next” key is pressed. If the control unit 205 detects that a close key on the detailed information screen is pressed in step S2210, the processing flow returns to step S2202.

If in step S2205 the control unit 205 determines that the detailed information key 3404 is not pressed, the processing flow proceeds to step S2206. In step S2206, the control unit 205 determines whether the stop key 3405 is pressed. If in step S2206 the control unit 205 detects that the stop key 3405 is pressed, the control unit 205 stops print processing of the selected print job EE and the print job FF is step S2212.

If in step S2206 the control unit 205 determines that the stop key 3405 is not pressed, the processing flow proceeds to step S2208. In step S2208, the control unit 205 determines whether the priority test print key 3403 is pressed. If in step S2208 the control unit 205 detects that the priority test print key 3403 is pressed, the processing flow proceeds to step S2215. If in step S2208 the control unit 205 determines that the priority test print key 3403 is not pressed, the processing flow proceeds to step S2209. In step S2209, the control unit 205 determines whether a close key is pressed. If in step 2209 the control unit 205 determines that the close key is not pressed, the processing flow proceeds to step S2205. On the other hand, if in step 2209 the control unit 205 determines that the close key is pressed, the control unit 205 finishes processing indicated in the processing flow.

In step S2215, the control unit 205 causes the operation unit 204 to display a setting screen relating to the test print processing of the selected print job EE and the print job FF. Similar to the processing of step S2211, the display format for displaying the detailed information of a plurality of print jobs is not limited. For example, the control unit 205 causes the operation unit 204 to display a setting screen relating to the test print processing of one print job on the first page and display a setting screen relating to the test print processing of another print job each time the “next” key is pressed.

Then, if the control unit 205 detects that an operator presses the print start key to accept the setting contents, the control unit 205 performs the following controls. The control unit 205 controls the printer unit 203 to execute test print processing of the selected print job EE and the print job FF after completing print processing of the currently processed print job AA and before starting print processing of the print job BB waiting for print processing.

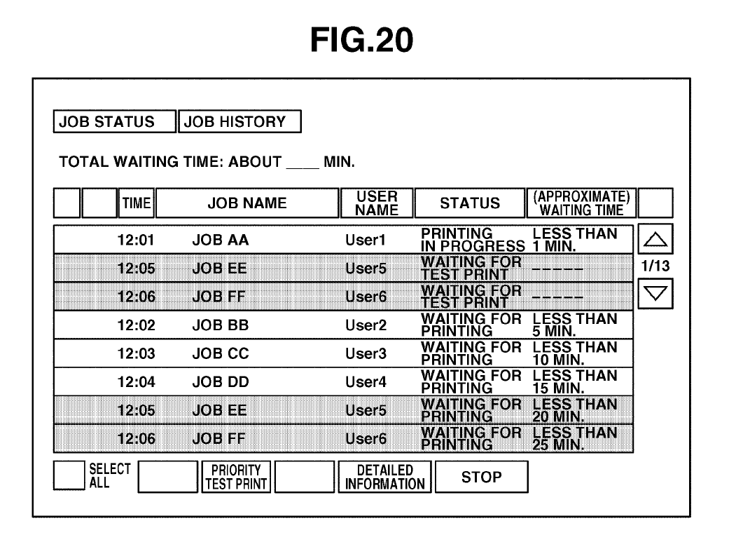

Then, in step S2219, the control unit 205 performs the following control. The control unit 205 causes the operation unit 204 to display a job status screen of FIG. 20 so that a user can recognize that test print processing of the print job EE and the print job FF starts after completing print processing of the currently processed print job AA and before starting print processing of the print job BB waiting for print processing.

Furthermore, the control unit 205 performs the following control to enable an operator to recognize that the test print job EE and the test print job FF are execution objects of the test print processing, not execution objects of the real print processing. Namely, the control unit 205 causes the operation unit 204 to display a message “waiting for test print” in a status field of the display zone of the test job information of the print job DD. In other words, the control unit 205 causes the operation unit 204 to display the message “test print waiting” so that a user can discriminate the real print processing of the job(job EE and job FF) and the test print processing of the job(job EE and job FF) displayed on the operation unit 204.

Then, the control unit 205 controls the printer unit 203 to start print processing of the test print job EE after completing print processing of the print job AA and then start print processing of the test print job FF after completing print processing of the test print job EE.

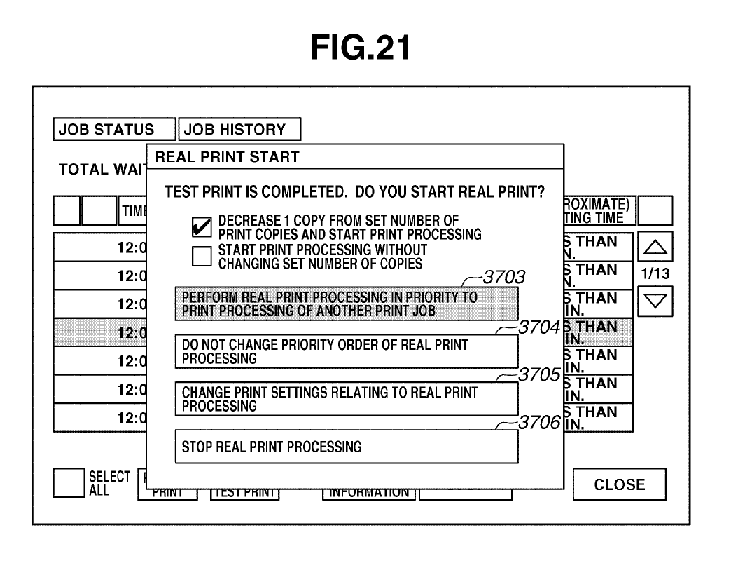

Then, if in step S2220 the control unit 205 determines that the test print processing of the test print job FF is completed, the processing flow proceeds to step S2221. In step S2221, the control unit 205 causes the operation unit 204 to display a real print setting screen relating to the print job EE and the print job FF as illustrated in FIG. 21.

In FIG. 21, the control unit 205 causes the operation unit 204 to display a “perform real print processing prior to print processing of other print jobs” key 3703 in an unselectable state using the gray-out method. Namely, if an operator selects a plurality of print jobs, the control unit 205 prohibits the printer unit 203 from starting real print processing of the selected plurality of print jobs prior to execution of other print jobs waiting for print processing.

Thus, the control unit 205 can prevent the execution order of jobs from being greatly changed compared to the original order designated by an operator, even when the execution priority orders of a plurality of print jobs in the real print processing are raised.

If in step S2222 the control unit 205 detects that a “change print settings relating to real print processing” key 3705 is pressed, the control unit 205 performs the following control. The control unit 205 causes the operation unit 204 to display a display screen for enabling an operator to change settings relating to real print processing of the print job EE and the print job FF. Then, the control unit 205 performs the processing of steps S2227 to S2230.

If in step S2222 the control unit 205 determines that the “change print settings relating to real print processing” key 3705 is not pressed, or if the processing of step S2229 is completed, or if in step S2230 the close key 2502 is pressed, the processing flow proceeds to step S2224.

If in step S2224 the control unit 205 detects that the “do not change priority order of real print processing” key 3704 is pressed, the processing flow proceeds to step S2202 without changing the execution priority order of the print job EE and the print job FF. In step S2202, the control unit 205 causes the operation unit 204 to display the print status screen illustrated in FIG. 16. On the other hand, if in step S2224 the “do not change priority order of real print processing” key 3704 is not pressed, the processing flow proceeds to step S2225.

In step S2225, the control unit 205 detects that a “stop real print processing” key 3706 is pressed, the processing flow proceeds to step S2233. In step S2233, the control unit 205 executes print stop processing for the print job EE and the print job FF. In other words, the control unit 205 deletes the print job EE and the print job FF from the HDD 209 and also deletes job information of the print job EE and the print job FF from the job list 2301.

Then, the processing flow proceeds to step S2202. In step S2202, the control unit 205 causes the operation unit 204 to display the operation screen that displays a list of job information of print jobs stored in the HDD 209.

Therefore, an operator can confirm a print result (product) of the test print processing of a print job. If the print result is different from a desired finishing state, an operator can eliminate useless real print processing of the print job. If in step the control unit 205 detects that a “stop real print processing” key 3706 is not pressed, the control unit 205 causes the operation unit 204 to execute the print processing of a printable job in step S2226.

For example, if the print processing of the print job BB and the print job CC is completed in a state where the real print setting screen for the print job EE and the print job FF illustrated in FIG. 21 is displayed, the control unit 205 can start real print processing of the print job EE and the print job FF even if the settings relating to the real print processing of the print job EE and the print job FF are not accepted.

In this case, the control unit 205 can perform the following controls.

(4) The control unit 205 controls the printer unit 203 to start print processing of a print job GG and a print job HH (i.e., print jobs following the print job EE and the print job FF) without temporarily stopping the print processing of the image forming apparatus. Thus, the productivity of the entire system can be maintained appropriately.

(5) The control unit 205 controls the image forming apparatus to temporarily stop print processing until the setting changes relating to the real print processing of the print job EE and the print job FF by an operator are accepted. In this case, the control unit 205 can prevent print processing of any following job from being performed prior to the print processing of the print job EE and the print job FF. Thus, the control unit 205 enables an operator to change settings relating to the real print processing of the print job EE and the print job FF without changing the output order of the jobs.

(6) The control unit 205 terminates the screen display illustrated in FIG. 21 and starts real print processing of the print job EE and the print job FF. Therefore, the control unit 205 can prevent the printing apparatus 100 from temporarily stopping the print processing without changing the output order of print jobs. Thus, the productivity of the entire system can be maintained appropriately.

Furthermore, when the screen display illustrated in FIG. 21 is terminated, the control unit 205 can cause the operation unit 204 to display a confirmation message (e.g., “The print job EE and the print job FF are ready to start printing. Do you start printing?”), thereby allowing an operator to instruct starting of the real print processing of the print job EE and the print job FF.

If the control unit 205 detects that the “YES” key is pressed by an operator, the control unit 205 controls the printer unit 203 to start real print processing of the print job EE and the print job FF. On the other hand, if the control unit 205 detects that the “NO” key (i.e., a key for prohibiting real print processing of the print job EE and the print job FF from starting) is pressed by an operator, the control unit 205 controls the printer unit 203 to start print processing of the print job GG and the print job HH that follow the job print job EE and the print job FF. Thus, the control unit 205 can execute a control reflecting an operator's intent.

Furthermore, the control unit 205 can select one of the above-described controls (4) to (6) according to, for example, a user mode.

According to the above-described controls, the printer unit 203 performs a test print of any following print job (i.e., a print job having a lower execution priority order) prior to execution of other print jobs, even if a large number of unprocessed print jobs are present in the printing system. Therefore, an operator can confirm a print result (product) of any succeeding job without a long waiting time. Furthermore, the printing system can process print jobs without greatly changing the execution order of print jobs designated by an operator.

Furthermore, as a method for processing print jobs without greatly changing the execution order being designated by an operator, the control unit 205 can perform the following control. For example, when the printing system accepts a plurality of print jobs, the control unit 205 prohibits the printer unit 203 from executing real print processing of a print job having a lower execution priority order prior to print processing of other print jobs.

An exemplary control performed by the control unit 205 is described below. It is now assumed that the control unit 205 causes the operation unit 204 to display the screen illustrated in FIG. 7. In this case, the control unit 205 displays print job AA to print job HH on a page of the job list 2301 illustrated in FIG. 7.

Furthermore, the control unit 205 causes a list counter 2310 to indicate that the displayed job list is the first page of 13 pages. According to this example, a total of 100 print jobs being mutually independent are stored in the HDD 209. A total of eight print jobs in the job list 2301 of FIG. 7 have higher execution priority orders (i.e., the order in starting print processing execution) compared to those of other print jobs.

In this condition, it is now assumed that an operator instructs to execute print processing of the 95th print job waiting for print processing after completing print processing of the currently processed print. In this case, the control unit 205 changes the execution priority order of the 95th print job, the execution order of print jobs may be greatly changed compared to the original order designated by an operator.

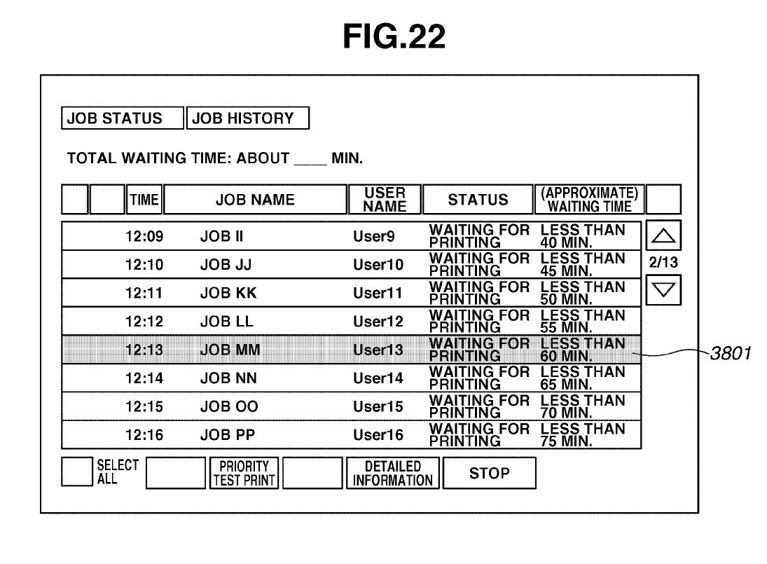

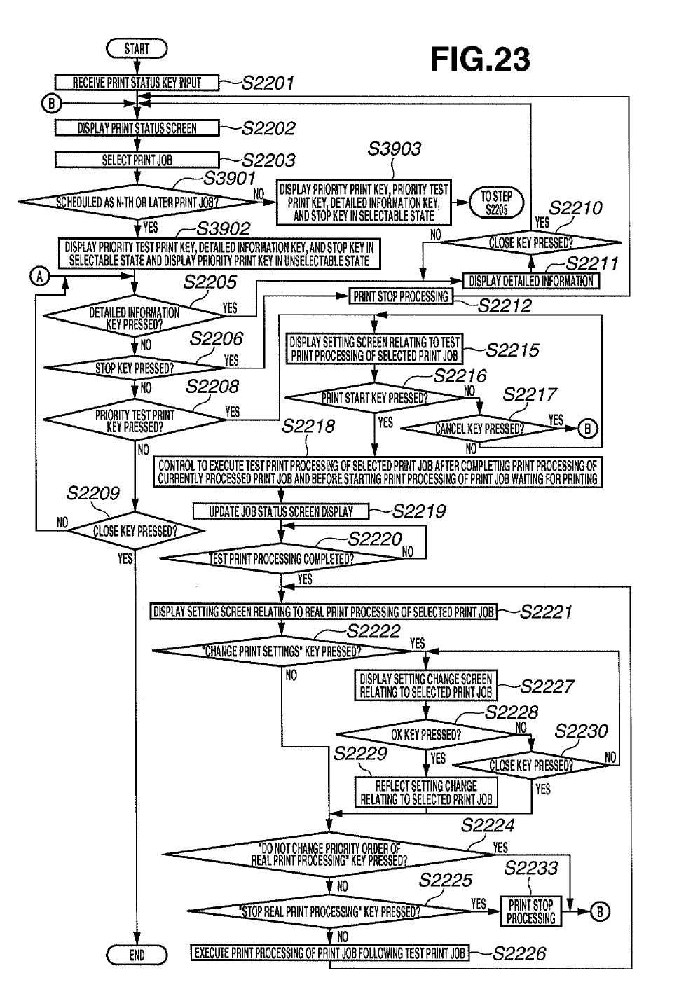

An exemplary control performed by the control unit 205 is described below with reference to a job status screen illustrated in FIG. 22 and a flowchart of FIG. 23. If in step S2201 of FIG. 23 the control unit 205 detects that the print status key is pressed, the processing flow proceeds to step S2202.

In step S2202, the control unit 205 causes the operation unit 204 to display the print status screen illustrated in FIG. 7. If the control unit 205 detects that the down-direction key 2311 is pressed by an operator, the control unit 205 causes the operation unit 204 to display a second job list 3801 on the job status screen illustrated in FIG. 22.

If in step S2203 the control unit 205 detects that a print job MM is selected, the processing flow proceeds to step S3901. In step S3901, the control unit 205 determines whether the selected print job is scheduled as a print job to be processed as an Nth or later print job (N is a natural number). In this embodiment, N is set to 10. The print job MM is a print job scheduled as a 13th print job to be processed in a state where the printer unit 203 is performing print processing of the print job AA.

If the control unit 205 determines that the execution priority order of the selected print job MM is equal to or lower than the tenth, the processing flow proceeds to step S3902. In step S3902, the control unit 205 performs a highlight display of the print job MM as illustrated in FIG. 22. Furthermore, the control unit 205 causes the operation unit 204 to display the priority test print key 3403, the detailed information key 3404, and the stop key 3405 in a selectable state and also display the priority print key 3402 in an unselectable state.

Namely, the control unit 205 allows an operator to perform test print processing of the selected print job prior to execution of other print jobs if the selected print job has an execution priority order equal to or lower than the Nth. Furthermore, the control unit 205 prohibits an operator from performing real print processing of the selected print job prior to execution of other print jobs. Then, the control unit 205 performs a predetermined control for the selected print job MM which is similar to the control described with reference to the flowchart of FIG. 6.

On the other hand, if in step S3901 the control unit 205 determines that the selected print job has an execution priority order higher than the tenth, the processing flow proceeds to step S3903. In step S3903, the control unit 205 causes the operation unit 204 to display the priority print key 3402, the priority test print key 3403, the detailed information key 3404, and the stop key 3405 in a selectable state. Then, the processing flow proceeds to step S2205. The control unit 205 performs processing similar to that described with reference to the flowchart of FIG. 6. If the processing proceeds to B in the flowchart of FIG. 6, the processing proceeds to B illustrated in the flowchart of FIG. 23. The value of N can be set to a predetermined value beforehand or can be set using the user mode key 505.

As described above, when the screen of FIG. 7 is displayed, the control unit 205 prohibits the printer unit 203 from performing priority print processing of the selected print job if the execution priority order of the selected print job equal to or lower than Nth. Therefore, even if a great number of independent print jobs waiting for print processing are present in the printing system, the printing system can perform a test print of a print job having a lower priority order prior to the print processing of other print jobs. Therefore, an operator can confirm a print result (product) of any succeeding job without a long waiting time. Furthermore, the printing system can process print jobs without greatly changing the processing order compared to the original order designated by an operator.

According to the above-described example, when only one print job is selected, the control unit 205 determines whether the selected print job has an execution priority order equal to or lower than the Nth. However, the printing system can be configured to allow an operator to select a plurality of print jobs. If an operator selects a plurality of print jobs, the control unit 205 can executes the following control.

The control unit 205 determines whether the selected plurality of print jobs include any print job having an execution priority order equal to or lower than the Nth. If the control unit 205 determines the print job having an execution priority order equal to or lower than the Nth is included, the processing flow proceeds to step S3902. Then, the control unit 205 can cause the operation unit 204 to display the priority test print key 3403, the detailed information key 3404, and the stop key 3405 in a selectable state and also display the priority print key 3402 in an unselectable state, in a state where the plurality of print jobs are selected, to obtain effects similar to the above-described effects.

Furthermore, if the number of print copies designated to a selected print job is one copy, an operator can obtain a print product by performing real print processing of this job rather than performing test print processing of this job. In this case, the control unit 205 prohibits the priority test print key 3403 from being selected so that an operator is not required to instruct a priority test print.

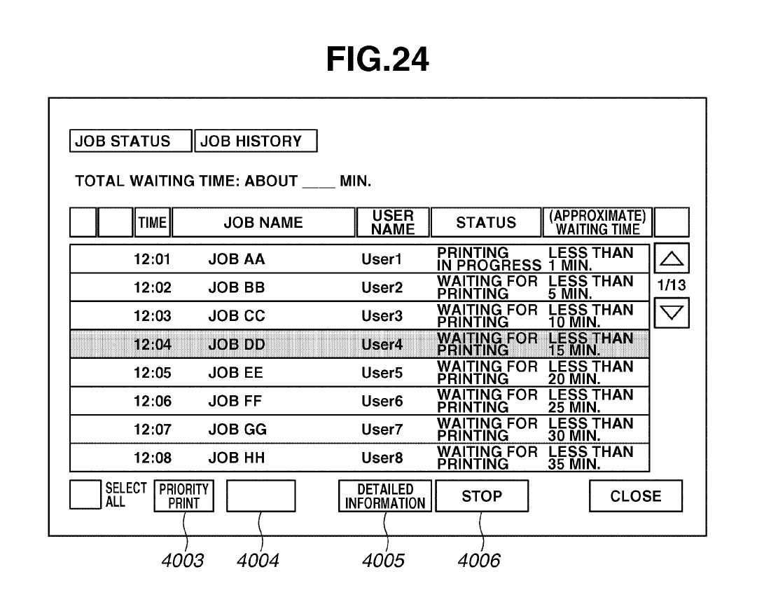

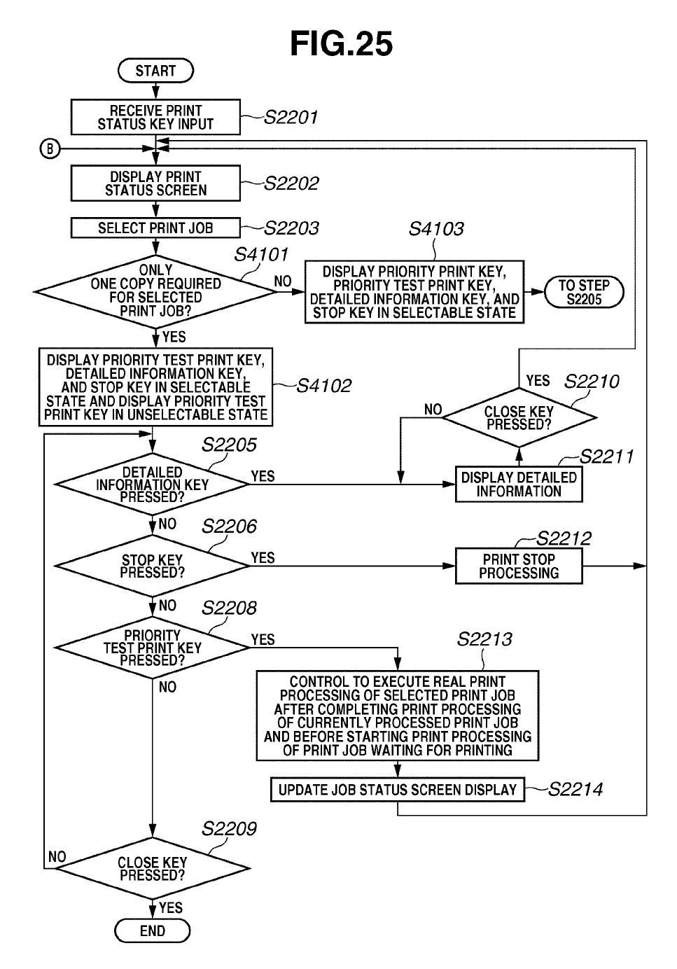

An exemplary control performed by the control unit 205 is described below with reference to a screen illustrated in FIG. 24 and a flowchart illustrated in FIG. 25. If in step S2201 of FIG. 25 the control unit 205 detects that the print status key is pressed, the processing flow proceeds to step S2202. In step S2202, the control unit 205 causes the operation unit 204 to display the print status screen.

For example, if in step S2203 the control unit 205 detects that a print job DD is selected, the processing flow proceeds to step S4101. In step S4101, the control unit 205 determines whether the number of print copies designated to the selected print job DD is one copy. If in step S4101 the control unit 205 determines that the number of print copies designated to the print job DD is not one copy, the processing flow proceeds to step S4103.

In step S4103, the control unit 205 causes the operation unit 204 to display a priority print key 4003, a priority test print key 4004, a detailed information key 4005, and a stop key 4006. Then, the processing flow proceeds to step S2205 to execute processing similar to the processing of the flowchart illustrated in FIG. 6.

If in step S4101 the control unit 205 determines that the number of print copies designated to the print job DD is one, the processing flow proceeds to step S4102. In step S4102, the control unit 205 causes the operation unit 204 to display the priority print key 4003, the detailed information key 4005, and the stop key 4006 in a selectable state and also display the priority test print key 4004 in an unselectable state.

Namely, the control unit 205 allows an operator to perform real print processing of the selected print job prior to execution of other print jobs when the number of print copies designated to the selected print job is one copy. Furthermore, the control unit 205 prohibits an operator from performing test print processing of the selected print job prior to execution of other print jobs.

Then, the control unit 205 performs a predetermined control for the selected print job DD which is similar to the control described with reference to the flowchart of FIG. 6 (including the control performed when the detailed information key 4005 is pressed and the control performed when the priority print key 4003 is pressed).

As described above, if the number of print copies designated to a selected print job is one copy in a state where the screen of FIG. 7 is displayed, the control unit 205 causes the operation unit 204 to display the priority test print key of a selected print job in a unselectable state. Therefore, an operator is not required to instruct about a priority test print.

The method for selecting a job is not limited to the above-described example (i.e., pressing a key on the operation unit 204 including a display screen). For example, an operator can use an arrow key and a selection button to select a job.

Furthermore, in the above-described exemplary embodiment, the operation unit 204 of the printing system 1000 displays the above-described operation screens and accepts various instructions from an operator who presses (or touches) the operation unit 204. However, a control unit of a host computer (e.g., the PC 103 or the PC 104) can have an operation screen similar to the operation screen of the operation unit 204.

Therefore, according to an exemplary embodiment, the host computer can display similar screens on its display unit and accepts any instruction or settings from an operator via the operation unit.

In this case, any instruction or settings accepted by the host computer can be transmitted to the printing system 1000 via the network 101. Then, the control unit 205 of the printing system 1000 performs various controls according to the instruction or settings received via the network 101.

Furthermore, the main control according to an exemplary embodiment is not limited to a control performed by the control unit 205 incorporated in the printing apparatus 100. For example, the UI operation control and the actual operation control of the printing system 1000 are two representative controls. The control unit 205 can execute the operation control of the printing system 1000, while the display control unit (or other UI control unit) can execute the UI operation control.

Furthermore, a control unit of an external apparatus, such as a PC or a remote controller, can execute all or part of the main control performed by the printing apparatus 100. A display unit of the external apparatus can perform various displays to realize interactive processing according to an exemplary embodiment.

Furthermore, the control unit of the external apparatus can accept various requests similar to the above-described operator requests via the display unit of the external apparatus. Furthermore, according to the accepted request, the control unit of the external apparatus can control the printing system 1000 including the printing apparatus 100 so as to realize an operation similar to the above-described operation.

In this manner, an external apparatus can realize the main part of the control for the printing apparatus 100. The printing system 1000 according to the above-described exemplary embodiments can bring the following effects.

For example, the exemplary embodiments of the present invention can solve the above-described conventional problems. For example, the exemplary embodiments of the present invention can realize a useful print environment that can be applied not only to an office environment but also to a POD environment.

For example, the exemplary embodiments of the present invention can realize a printing system that can operate with higher productivity and reduce a work load of an operator, and can be used in an actual work site of the POD or other print environment. Especially, the exemplary embodiments of the present invention bring the following effects.

For example, when there are two or more print jobs waiting for print processing in a printing system, the printing system can be configured to enable an operator to select a test print prior to execution of other jobs for the purpose of confirming a result of a designated print job.

Thus, the exemplary embodiments of the present invention can satisfy both easiness in handling and improvement in productivity. In this manner, the exemplary embodiments of the present invention can realize a useful and flexible print environment that can be used in various use cases or can satisfy requirements in the conventional POD environment. The exemplary embodiments of the present invention can provide various systems for manufacturing products.

A host computer (e.g., the PC 103 or the PC 104) can install a program from an external device to realize the functions of the above-described exemplary embodiments. In this case, the host computer can install various data from an external device to display operation screens similar to the operation screens of the above-described exemplary embodiments. The host computer can cause its display unit to display various user interface screens. According to this arrangement, a group of information including programs can be supplied to an output apparatus from an external storage medium via a storage medium (e.g., CD-ROM, flash memory, or FD) or a network.

Furthermore, a storage medium storing software program code for realizing the functions of the above-described exemplary embodiments can be supplied to a system or an apparatus including various devices. A computer (or CPU or micro-processing unit (MPU)) in the system or the apparatus can read the program code from the storage medium and execute the program to operate the devices to realize the functions of the above-described exemplary embodiments. In this case, the program code itself can realize the functions of the exemplary embodiments. A storage medium storing the program code can constitute the present invention.

In this case, the type of program can be any one of object code, interpreter program, and OS script data. The equivalents of programs can be used if they possess comparable functions. Accordingly, the present invention encompasses the program code installable on a computer when the functions or processes of the exemplary embodiments can be realized by the computer.

A storage medium supplying the program can be selected from any one of a floppy® disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R). In this case, the program code itself read out of the storage medium can realize the functions of the exemplary embodiments. A storage medium storing the program code can constitute the present invention.

The method for supplying the program includes accessing a web site on the Internet using the browsing function of a client computer, when the web site allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different web sites. Namely, the present invention encompasses World Wide Web (WWW) servers or ftp servers that allow numerous users to download the program files so that the functions or processes of the present invention can be realized on their computers.

Enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Moreover, an operating system (OS) or other application software running on a computer can execute part or all of actual processing based on instructions of the programs.

Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

The present invention can be applied to a system including plural devices or can be applied to a single apparatus.

Furthermore, the present invention encompasses supplying program code to a computer with a storage (or recording) medium storing the program code. In this case, the system or the apparatus can obtain effects of the present invention by reading software programs from the storage medium to realize the present invention.

The present invention is not limited to the above-described exemplary embodiments and can be modified in various ways within a scope of the present invention (including a combination of the above-described exemplary embodiments). For example, according to an exemplary embodiment, an external controller provided separately from the control unit 205 of the printing apparatus 100 can execute part of all of the above-described various controls.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-000513 filed Jan. 5, 2007, which is hereby incorporated by reference herein in its entirety.

What is claimed is:

1. A printing system capable of accepting a plurality of print jobs, comprising:
a selection unit configured to select a print job to be processed by a printer unit from a plurality of print jobs waiting for print processing, wherein the plurality of print jobs includes a first job being currently processed by the printer unit, a second job following the first job and scheduled to be processed by the printer unit, and a third job following the second job and scheduled to be processed by the printer unit; and
a control unit configured to control the printer unit to execute, in case where the third job is selected by the selection unit and an instruction to execute priority test print processing of the third job is accepted, the test print processing of the third job after completing print processing of the first job and before starting print processing of the second job.

2. The printing system according to claim 1, wherein the plurality of print jobs further includes a fourth job following the third job and scheduled to be processed by the printer unit, wherein the control unit is configured to control the printer unit to execute, in case where the third job and the fourth job are selected by the selection unit and an instruction to execute priority test print processing of the third job and the fourth job is accepted, the test print processing of the third job and the fourth job after completing print processing of the first job and before starting print processing of the second job.

3. The printing system according to claim 1, further comprising a display control unit configured to control a display unit so that a user can discriminate the third job and the test print processing of the third job displayed on the display unit.

4. The printing system according to claim 1, wherein the control unit causes a display unit to display a setting screen that enables a user to perform print settings relating to real print processing of the third job after completing the test print processing of the third job.

5. The printing system according to claim 4, wherein the control unit permits the printer unit to start execution of the second job after completing the test print processing of the third job, when the display unit displays the setting screen relating to the real print processing of the third job.

6. The printing system according to claim 1, wherein the control unit prohibits the printer unit from executing real print processing of the third job until an execution instruction is received from an operator after completing the test print processing of the third job.

7. The printing system according to claim 1, wherein the control unit permits the printer unit to execute the test print processing of the third job after completing the print processing of the first job and before starting print processing of the second job, and the control unit prohibits the printer unit from executing real print processing of the third job after completing print processing of the first job and before starting print processing of the second job.

8. The printing system according to claim 1, wherein in case where the printer unit executes real print processing of the third job, the control unit subtracts a number of print copies having been printed for the test print processing of the third job from a set number of print copies designated to the third job.

9. A method for controlling a printing system capable of accepting a plurality of print jobs, comprising:
selecting a print job to be processed by a printer unit from a plurality of print jobs waiting for print processing, wherein the plurality of print jobs includes a first job being currently processed by the printer unit, a second job following the first job and scheduled to be processed by the printer unit, and a third job following the second job and scheduled to be processed by the printer unit; and
controlling the printer unit to execute, in case where the third job is selected and an instruction to execute priority test print processing of the third job is accepted, the test print processing of the third job after completing print processing of the first job and before starting print processing of the second job.

10. The method according to claim 9, wherein the plurality of print jobs further include a fourth job following the third job and scheduled to be processed by the printer unit, wherein the method further comprises:
controlling the printer unit to execute, in case where the third job and the fourth job are selected and an instruction to execute priority test print processing of the third job and the fourth job is accepted, the test print processing of the third job and the fourth job after completing print processing of the first job and before starting print processing of the second job.

11. The method according to claim 9, further comprising controlling a display unit so that a user can discriminate the third job and the test print processing of the third job displayed on the display unit.

12. The method according to claim 9, further comprising controlling a display unit to display a setting screen that enables a user to perform print settings relating to real print processing of the third job after completing the test print processing of the third job.

13. The method according to claim 12, further comprising permitting the printer unit to start execution of the second job after completing the test print processing of the third job, when the display unit displays the setting screen relating to the real print processing of the third job.

14. The method according to claim 9, further comprising prohibiting the printer unit from executing real print processing of the third job until an execution instruction is received from an operator after completing the test print processing of the third job.

15. The method according to claim 9, further comprising permitting the printer unit to execute the test print processing of the third job after completing the print processing of the first job and before starting print processing of the second job, and prohibiting the printer unit from executing real print processing of the third job after completing print processing of the first job and before starting print processing of the second job.

16. The method according to claim 9, further comprising, in case where the printer unit executes real print processing of the third job, subtracting a number of print copies having been printed for the test print processing of the third job from a set number of print copies designated to the third job.

17. A computer-readable storage medium containing a computer-executable computer program for controlling a printing system capable of accepting a plurality of print jobs, the computer program comprising:
a code to select a print job to be processed by a printer unit from a plurality of print jobs waiting for print processing, wherein the plurality of print jobs includes a first job being currently processed by the printer unit, a second job following the first job and scheduled to be processed by the printer unit, and a third job following the second job and scheduled to be processed by the printer unit; and
a code to control the printer unit to execute, in case where the third job is selected and an instruction to execute priority test print processing of the third job is accepted, the test print processing of the third job after completing print processing of the first job and before starting print processing of the second job.
